(19) United States
(12) Patent Application Publication
(10) Pub. No.: US 2007/0038702 A1
(43) Pub. Date: Feb. 15, 2007

(54) Communications data management

(75) Inventors: Stuart Taylor, Essex (GB); Anthony Sycamore, Wiltshire (GB)

Correspondence Address: DUANE MORRIS, LLP;IP DEPARTMENT, 30 SOUTH 17TH STREET, PHILADELPHIA, PA, 19103-4196, US

(73) Assignee: STEELHEAD SYSTEMS, LTD., London (GB)

(21) Appl. No.: 10/550,368

(22) PCT Filed: Mar. 22, 2004
(86) PCT No.: PCT/GB04/01218

§ 371 Date: Jun. 30, 2006

(30) Foreign Application Priority Data
Mar. 20, 2003 (GB) 0306463.1

(51) Int. Cl. G06F 15/16

(52) U.S. Cl. 709/206

(57) ABSTRACT

A method of a recipient processing a received e-mail to cause data interaction is described. The method comprises: reading a text-based data structure within the text body of the received e-mail message; identifying some pre-stored data of the recipient by use of the data structure; and causing an interaction to occur with the pre-stored data, the interaction being determined by the contents of the received e-mail.

### FIELD OF THE INVENTION

The present invention concerns improvements relating to communications data management, and more particularly, though not exclusively, to an automated method of organising a user's inbox to sort incoming e-mail (electronic mail) messages. The present invention also has application to the remote control and updating of applications using e-mails and the formation of secure e-mail consortia.

### BACKGROUND OF THE INVENTION

Ever since the emergence of the Internet as a viable and reliable communications network, text-based communications via the Internet, namely e-mail has proliferated. Many communications which would previously have been effected by facsimile or telephone are instead now handled by e-mail. The reason for such a change in the manner of communication is due to several advantageous factors. Unlike conventional mail, an e-mail can be delivered to a recipient in a matter of minutes regardless of the recipient's location. Additional information can also be sent with the e-mail such as an electronic file or a hyperlink such that the need for the sending of storage media can be obviated. Furthermore, the cost of sending an e-mail is a fraction of that of conventional mail or even a facsimile.

Various e-mail packages such as Microsoft Outlook® Lotus Notes® and Novell Groupwise® exist for handling the creation, sending and reading of received e-mails. Each of these packages creates an inbox on the recipient's computer where e-mails are initially stored that have been retrieved from the recipient's e-mail address on their respective e-mail server. All new messages are typically highlighted such that all unread e-mails are brought to the recipient's attention. Thereafter, the recipient can read the e-mails and determine the category to which the information contained in the e-mail belongs. Subsequently, the recipient can decide where to store (file) the e-mail in their e-mail folder structure or whether it is to be deleted.

With the prolific increase in the number of e-mail communications that recipients are now receiving, managing the recipient's inbox to ensure that each received e-mail is properly filed has become an onerous task. There is a significant problem with manual sorting and filing and attempts have been made (see for example U.S. Pat. No. 6,216,165) to address this by the introduction of what have been termed ‘automated’ e-mail filing methods. These methods involve the user having to manually set up message-specific rules, which act on incoming e-mail to recognise and thereafter act on received e-mails. This is achieved by searching the subject field of an e-mail for predetermined words or recognising a predetermined sender's address in the header field. Sometimes the required programming needs to access an external database to achieve its desired effect.

However, such methods are difficult to set up and maintain placing a significant burden on the receiver. Typically, users tend to set up such methods initially but not maintain them due to this burden. In any case, such systems and methods can at best only be partially successful because e-mails from new senders regarding new subjects or in a ‘free text’ format cannot, by definition, be handled by such systems.

Another problem with existing manual and automated methods is that old e-mails (i.e. those outdated by similar e-mails with newer content) persist and require deletion. The problems caused by such e-mails is particularly evident in the case where there are a stream of e-mail messages transmitted to a recipient regarding a constantly changing parameter, such as a stock market quote. Here the recipient's inbox can quickly become clogged with e-mails to be read as well as outdated information.

Some of these problems amongst others have been considered in International Patent Application WO 01/76264A and WO 01/76119A. These prior art documents propose the creation of a centralised web mail service where the web based communications contain an XML message. This solution is complex and relies on a central organising server to arrange data destined for a recipient. Also, this solution requires a person wishing to participate to register with the central server and to send messages using Internet-based communications. The use of web communications means that messages are susceptible to screening and blocking by firewalls. This is because the content of such Internet communications can be analysed and if found to be prohibited, can be filtered preventing the user receiving the message. Also, this prior art system implements a pull model where information has to be pulled from a web site. This is not ideal in that it makes the recipient have to implement more procedures (such as the setting up of an alert channel) to get the data than in a push model. Furthermore, the data structure provided requires the recipient to access the originating sender in order to fully understand its meaning. This is non-ideal as it does not alleviate the issue of communications delays in taking some action with the data.

It is desired to overcome or at least substantially reduce the above-described problems by the provision of an improved method of handling received e-mails.

### SUMMARY OF THE PRESENT INVENTION

According to one aspect of the present invention, there is provided a method of a recipient processing a received e-mail to cause data interaction; the method comprising: reading a text-based data structure within the text body of the received e-mail message; identifying some pre-stored data of the recipient by use of the data structure; and causing an interaction to occur with the pre-stored data, the interaction being determined by the contents of the received e-mail.

The present invention also extends to a method of filing a received e-mail message in a point to point communication, the method comprising: reading a self-describing text-based data structure within the received e-mail message; comparing the self-describing data structure to a plurality of pre-stored data structures; and storing the contents of the received e-mail message in a folder to which the data structure corresponds, wherein the reading, comparing and storing steps are carried out without any non-local information being required.

The e-mail is therefore categorised by way of its data structure and is filed truly automatically without requiring any registration or predetermined configuration of the sender's machine or reliance upon any other remote information. This advantageously keeps inbox clutter to a minimum with there being no requirement for the recipient to configure or arrange his machine to accept these new types of e-mails and keeps the e-mail self contained.

The use of a text-based data structure within an e-mail, means that there are no problems with firewalls as the text within an e-mail does not get parsed for determining whether to block a received communication. In this way the present invention does not suffer from the problems described in relation to web-based communications.

The present invention enables data to go straight into a recipients inbox which advantageously operates as a push model rather than a pull model. In this way the recipient does not have to set up of carry out any special procedures to view the data.

The above described system, including the present invention embodied in a software application, seeks to allow a user (sender or recipient) to read, write, send and receive XML messages passed over e-mail which, on receipt, dynamically constructs a view onto the data at the recipient's computer. This view allows the content of the message to be manipulated based on any of the fields defined by the sender rather than the traditional e-mail practice of the receiver having to sort by say Sender, Subject, Time Received etc. The application does this by sending both the XML schema describing the data and the associated data fitting the schema structure in a tagged XML format (namely as text characters) in the body of the application.

Using this concept, multiple senders can send information in identical data structures to one recipient and this content is automatically co-mingled for the recipient as if it were one original recordset irrespective of the initial multiple sources of information. In this way problems requiring multiple senders to contribute previously unstructured information to one end user in a co-mingled and data structured way are solved within an e-mail context.

This concept is enhanced further as a single recipient may of course receive varying data structures from different senders. As such the application automatically creates a folder containing for each distinct XML schema / recordset. Incoming messages are then filed automatically into the correct folder using the following logic:
if the data structure is recognised from an earlier message, the e-mails are filed together,
if not a new folder is set up and the new data structure and associated data filed accordingly

This solves the need for the recipient to file incoming messages and helps de-clutter the recipients inbox. As similarly structured content is delivered to the user over time, a database key system is definable by the sender to specify that new e-mails replace old e-mails (again filed in the correct older) to ensure that e-mail content is up to date and old e-mails are deleted automatically without recipient intervention. As such, a delete and insert operation effects an update operation on the data. In this way the sender can control the view (both structure and timely content) that the recipient has on data the sender wishes to send.

The application therefore leverages the ease of e-mail and combines with database style functionality without any database knowledge required on the part of the recipient.

A consequence of this data structure technique is that multiple folders will appear on the recipients machine as varying schema are sent over time.

The present invention, using an e-mail message:
a) allows structured data to be communicated via e-mail whilst retaining its structured form and to be viewed by the recipient in its structured form.
b) creates folders specifically designed to hold a particular data structure without any intervention by the recipient.
c) files similarly structured messages automatically and allow full sorting/searching capability on any field defined in the structure.
d) allows multiple records—i.e. a multiple row dataset—to be packed up and sent in one standard e-mail message and be reconstructed into individual records by the recipient's computer.
e) allows data of a changing nature to be sent via e-mail with the recipient always seeing the latest view only.
f) allows structured data contained within e-mails to be automatically written to a database file external to the e-mail application.

The present invention has the following specific advantages/features:
a) Structured data can be sent and replied to via e-mail codified within the message itself, without the need for attachments/external programs (e.g. spreadsheets) to view the data. Sending e-mails without attachments means; no firewall problems, no virus risk and no action required by user (e.g. opening the attachment).
b) New data structures can be sent to recipients and automatically folders are created and e-mails filed thereby reducing filing or rule creation effort by the end user and creating bulletin-board like functionality within e-mail clients.
c) Similar structured data from multiple recipients can be co-mingled and combined into one view and fully sortable instantly. Previously structured data sent as attachments to e-mail had to be combined by the recipient into one file to allow data sorting across all records.
d) A user can send multiple records of a database or send multiple messages to the same recipient within just one standard e-mail message with no attachments. This saves in-box clutter and reduces network traffic and processing. Once received the single e-mail reconstructs into individual records allowing sorting, sifting and other data manipulation by the recipient.
e) The recipient does not need to discard old messages as this clean-up is done by the sender. Using the applicant's program (Steelhead Application), the sender has control over the messages as displayed at the recipient's computer and can delete out of date records remotely, or update information where it has changed.
f) No new data viewer or parsing application is needed by the recipient, and records received are automatically accessible by other applications in the recipient's environment, thereby allowing corporate systems to communicate without opening up incremental firewall holes as the e-mail server connections are used and only text information is being transferred.

Applications of the different aspects of the present embodiments of the invention as listed under the lettering used above are:
a) The Steelhead Application turns standard e-mail messaging into a connectivity system for structured data communication. As such the following structured data applications could evolve in areas that are enhanced by structured information (not exclusive list):
   Pricing (e.g.: Bond Prices, Stock Prices, Commodities, Other Financial Instruments, Catalogues, Gambling odds, Products and Service Prices and Offers)
   Listings (e.g.: Property, Entertainment, Classifieds, Timetables, Directories)
   News (e.g.: Business News, Weather and Sports Information, Surveys, Research, Reference)
   EDI functions (e.g.; Requests for Proposals (RFP), Bids, Inventory, Orders, Invoices, Transactions)
   Management information (e.g.: Budgets, Project updates, Client and sales information, Policies, Surveys, Market Research)
   Group Communication (e.g. creating distributed bulletin board like folders around certain topics)
b) Same as a)
c) Same as a)
d) Same as a) and especially for bulk data requirements that are likely to be found in Pricing and Listings applications where there is information on hundreds or thousands of records to be delivered to the recipient.
e) Same as a) and d) and especially for frequently changing data requirements that are likely ‘to be found in Pricing applications particularly in Financial markets and News applications where the same record has fields that change regularly so require modification rather than additional data addition.
f) Same as a) and especially EDI functions where another application will react to the data sent—for instance RFP data will result in a call to an automated Bid engine or invoice data will be automatically picked up and entered into an accounting system.

Further advantages of the different aspects of the present invention are described later.

In summary, different aspects of the present invention described in the specific description address at least the following seven problems experienced by e-mail users prior to the invention:
1. e-mail often arrives in a “free text” format, and as such similar e-mails (i.e. those containing similar data) from different senders are not co-mingled without cut/paste effort on the part of the recipient;
2. messages are not filed on receipt without setting up pre-defined in-box rules;
3. old e-mails (i.e. those outdated by similar e-mails with newer content) persist and require deletion;
4. groups of data contributors (referred to as consortia) have no “enforcer” of a data structure when sending data the same recipient(s) by e-mail in supposedly the same format. This allows errors in data structure on the part of one or more senders to jeopardise the combined recordset the receiver is trying to combine from the multiple e-mails;
5. requests for information sent to multiple recipients asking for feedback in a pre-defined format are not automatically co-mingled upon receipt, that is the data in the reply e-mails are not co-mingled as returns come in without some pre-programming effort typically requiring an external database;
6. creating an encrypted environment requires the sender and recipient to co-ordinate prior to the sending the e-mail which is not always convenient. For example, the recipient prior to this invention would be required expressly to make their public key available to the sender; and
7. cross referencing of information between e-mail folders was not previously possible as data structures can be defined to be extensible with table database style table joins possible using the structured nature of the data.

According to another aspect of the present invention there is provided a method of updating a remote data structure or process, the method comprising: reading a text-based processing instruction within the text body of a received e-mail message; accessing pre-stored data relating to the remote data structure or process; updating the pre-stored data in accordance with the text-based processing instruction to effect control.

According to another aspect of the present invention there is provided a method of filing content of a received instant messaging communication, the method comprising: reading a self-describing text-based data structure within the text body of the received instant messaging communication; comparing the self-describing data structure to a plurality of pre-stored text-based data structures; and storing the received data content of the instant messaging communication or a significant part thereof in a selected data folder to which the received text-based data structure corresponds, the method requiring no external access to data to carry out the reading, comparing and storing steps.

According to another aspect of the present invention there is provided a method of updating a remote data structure or process, the method comprising: reading a text-based processing instruction within the text body of a received instant messaging communication; accessing pre-stored data relating to the remote data structure or process; and updating the pre-stored data in accordance with the text-based processing instruction to effect control.

According to another aspect of the present invention there is provided a method of a recipient processing a received instant messaging communication to cause data interaction; the method comprising: reading a text-based data structure within the text body of the received instant messaging communication; identifying some pre-stored data of the recipient by use of the data structure; and causing an interaction to occur with the pre-stored data, the interaction being determined by the contents of the received instant messaging communication.

### BRIEF DESCRIPTION OF THE DRAWINGS

FIG. 1 is a schematic block diagram showing a communications system within which an apparatus according to a first embodiment of the present invention is implemented;

FIG. 2 is a flow diagram showing the operation of the apparatus of FIG. 1 in implementing the first embodiment of the present invention;

FIG. 3 is flow diagram showing the initialisation step of the method shown in FIG. 2 in greater detail;

FIG. 4 is flow diagram showing the folder processing step of the method shown in FIG. 2 in greater detail;

FIG. 5 is flow diagram showing the create definitions step of the method shown in FIG. 2 in greater detail;

FIG. 6 is flow diagram showing the create/modify database representation step of the method shown in FIG. 2 in greater detail;

FIG. 7 is flow diagram showing the creating and sending step of the method shown in FIG. 2 in greater detail;

FIG. 8 is flow diagram showing the database record processing step of the method shown in FIG. 2 in greater detail;

FIG. 9 is a screen shot representation of an inbox generated by the apparatus of FIG. 1;

FIG. 10 are examples of the XML code structure of a received e-mail according to the first embodiment;

FIG. 11 is a schematic block diagram showing the way in which the apparatus of the present invention interacts with senders and other applications within the recipient's computer;

FIG. 12 is a schematic block diagram showing a communications system within which an apparatus according to a second embodiment of the present invention is implemented;

FIG. 13 is a schematic block diagram showing the Schema manager of FIG. 12 in greater detail;

FIG. 14 is a flow diagram showing the operation of the Schema manager of FIG. 12 in implementing the second embodiment of the present invention;

FIG. 15 is a screen shot representation of a spreadsheet type grid (which replaces the normal new mail window) for input of data generated by the apparatus of FIG. 12;

FIG. 16 is a screen shot representation of a series of drop down boxes used for selecting a column group, for use in updating certain viewable data at the recipient; in this case the selected fields of the schema are the sender's e-mail address, read receipt recipient and the subject/schema title;

FIG. 17 is a screen shot representation of a field chooser type view option box which can be used to select columns that the sender has sent which the recipient is interested in viewing;

FIG. 18 is a screen shot representation of a spreadsheet plug-in used to generate new e-mails directly from the spreadsheet that fit the schema requirements; and

FIGS. 19a to 19e, 20a to 20e, 21a to 21b, 22a to 22c, and 23a to 23c are textual representations of exemplary data structures used to illustrate the capability of a third embodiment of the present invention.

### DETAILED DESCRIPTION OF PREFERRED EMBODIMENTS OF THE PRESENT INVENTION

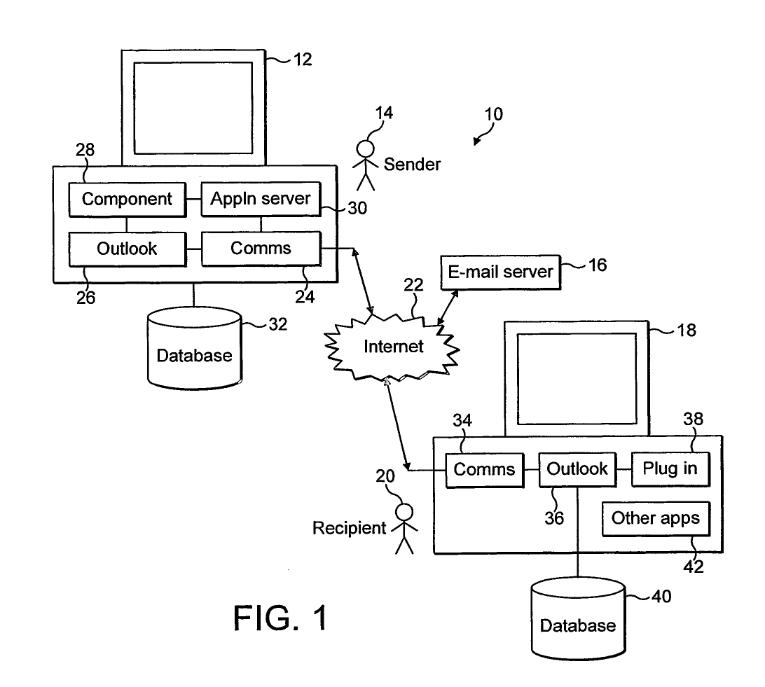

Referring to FIG. 1, a system 10 in which an embodiment of the present invention is deployed is shown. The system 10 comprises a first personal computer 12 of a sender 14, a remote e-mail server 16, a second personal computer 18 of a recipient 20 and a wide area communications network 22 such as the Internet connecting together each of the above.

The first personal computer 12 comprises four software modules, which function to create and send so-called 'structured’ e-mails (also referred to herein as Clovismail) to the recipient 20 via the e-mail server 16 in accordance with an embodiment of the present invention. A communications module 24 handles the communications functionality and can provided by any conventional Internet communications software, for example an ADSL link manager. The communications module 24 sends out structured e-mails which have been created by a local e-mail handling application module (in this embodiment Microsoft Outlook™) 26 and also supports general Internet communications for the first computer 12. The local e-mail handling application module 26 is configured by a component module 28, which in turn feeds off an application server 30. The specific way in which Outlook 26 is configured to generate these structured e-mails in conjunction with the component module 28 is described in detail later. However, the component module 28 (also known as a plug-in) ensures that the content of a structured e-mail is in the correct format to be recognised by the receiver and processed accordingly. The application server 30 can obtain the raw information that it needs for the content of a structured e-mail, through its link to the Internet 22 via the communications module 24. The first computer 12 has access to a local database 32 for storing information received regarding content of structured e-mails, which are to be transmitted as well as other local information.

Whilst the above description of the first computer 12 of the sender 14 is directed to use of the application server 30 to obtain raw information for the content of a structured e-mail, it is not necessary to have such an application server 30 as the content can simply be generated by the sender 14 using the local e-mail handling application module 26 and the component module 28. However, the provision of a dedicated server 30 enables the constant generation of e-mails containing the latest information obtained from relevant sources on the Internet (for example from a stock exchange for a portfolio of continually changing stock prices). Also, the dedicated server can obtain its stream of data from the local database 32.

The e-mail server 16 is a conventional e-mail server which simply acts as a routing engine for e-mail for the recipient. It is to be appreciated that the e-mail server 16 does not act as a web-based e-mail host such as Yahoo.com™ or Hotmail.com™, but rather as a conventional e-mail router such as Freeserve.com™, such that the recipient dialling in to access his structured e-mail, simply has that structured e-mail delivered to the second computer 18 where it can be accessed, filed and viewed.

The second computer 18 comprises a communications module 34 and a local e-mail handling application module 36 which are similar to the corresponding modules 24, 26 of the first computer 12. In order for the second computer to be able to distinguish and handle Clovismail, a plug-in 38 for the local e-mail handling application module 36 is provided. The second computer 18 also comprises a local database 40 for use in storing e-mails and their contents and has a plurality of other applications 42 (such as Microsoft Excel™) implemented which can interact with the data of a received Clovismail.

Therefore, the skilled addressee will immediately appreciate that the implementation of the present invention does not require much in the way of new software or indeed any new hardware. Rather, the provision of the appropriate plug-in 38 at the recipient 20 is sufficient for him to be able to receive and process Clovismails. The generation of such structured messages only requires the sender 14 to have an appropriate component module 28 for their local e-mail handling application module 26.

Whilst not shown in FIG. 1, there may be several other senders of structured e-mails to the recipient 20 and the following description of how the single sender 14 operates is equally applicable to the multiple sender scenario.

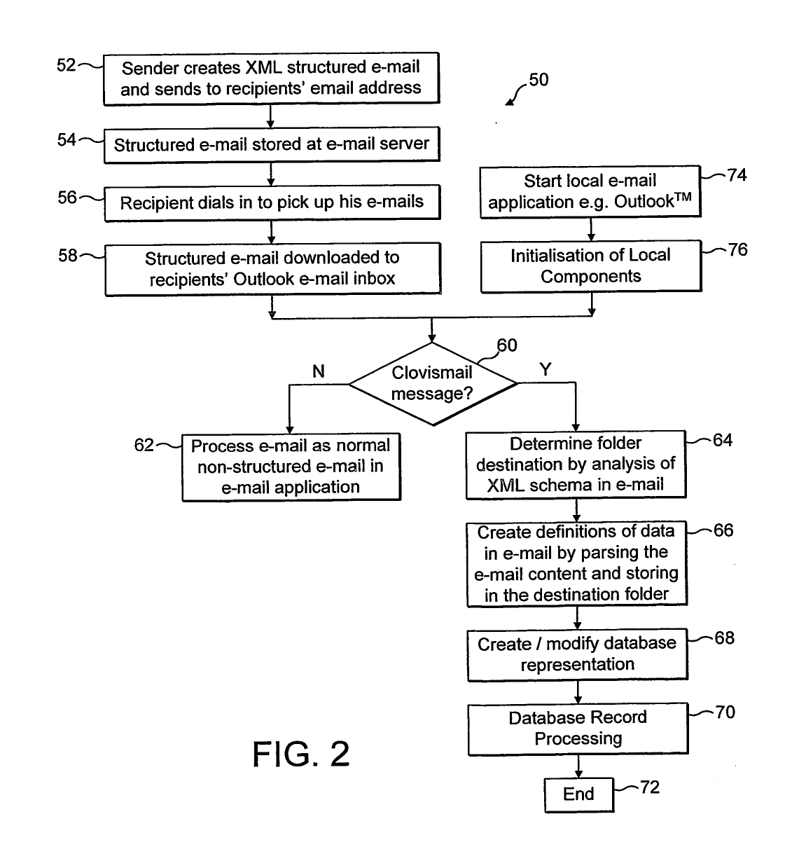

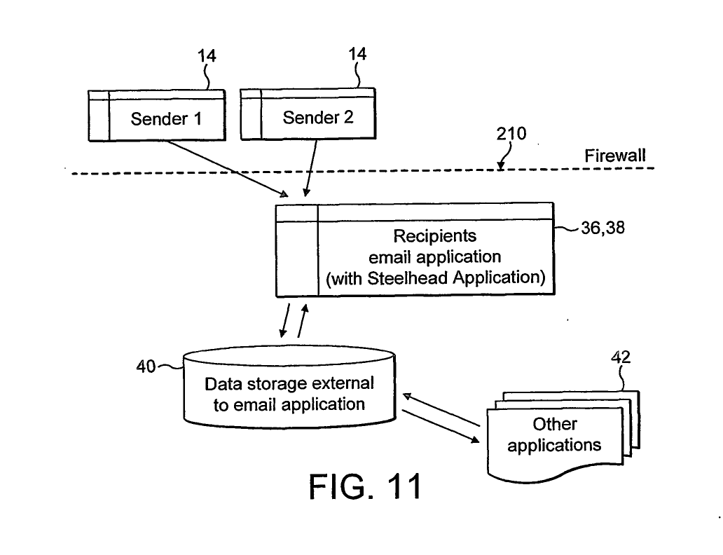

FIG. 2 shows a flow chart of a method 50 embodying the present invention of the steps of creating, sending, filing and processing of a structured e-mail using the above described system 10. The method 50 commences with the sender 14 creating at Step 52 an XML structured e-mail and thereafter sending this to the recipient's e-mail address in a conventional known manner. This process is described in greater detail in later with reference to FIG. 7.

The structured e-mail is stored at Step 54 at the remote e-mail server 16 of the intended receiver 20. At some point after the e-mail server 16 has received the structured e-mail, the communications module 34 of the second computer 18, dials in at Step 58 to check if there is any mail for the recipient 20. It is to be appreciated that the frequency with which the communications module 34 dials in is variable and is dependent on the communications link set up between the e-mail server 16 and the second computer 18. For example, a simple PSTN modem may dial up infrequently and on recipient prompting, whereas an ASDL connection may dial up every few minutes automatically and thereby ensure retrieval of the mail in a relatively short time after it has been stored by the remote e-mail server 16. The retrieved structured e-mail is stored also at Step 58 in the inbox of local e-mail handling application module 36 resident on the recipient's second computer 18.

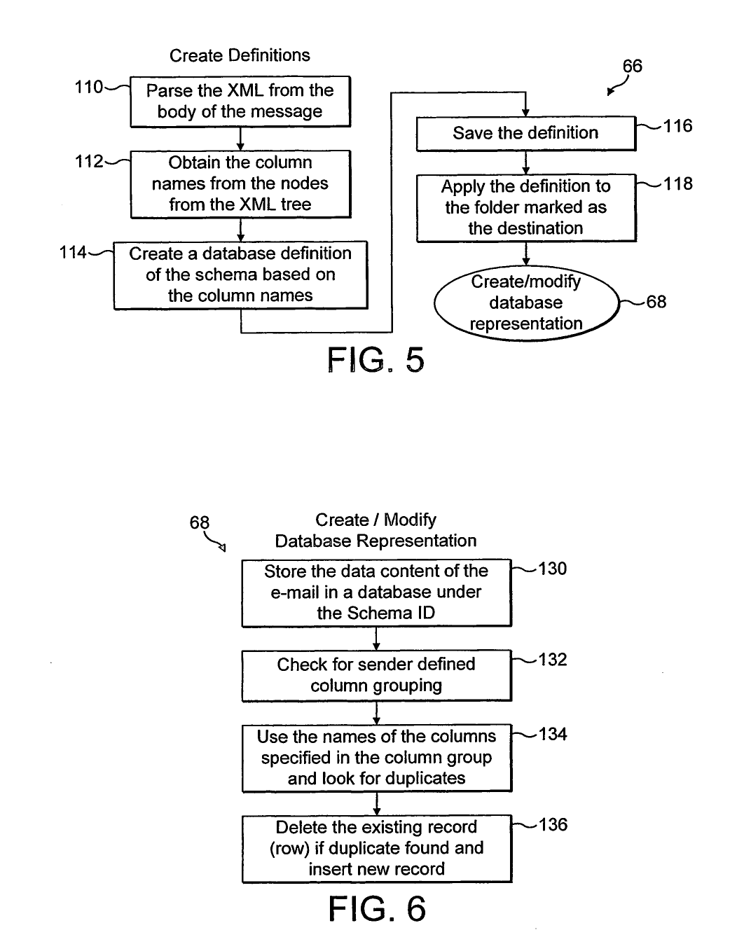

The local e-mail handling application module 36, which has previously been specifically configured by the plug-in 38 to handle Clovismail, then checks at Step 60 whether the e-mail just downloaded at Step 58 into the inbox is a Clovismail. If it is not recognised as being such, then the e-mail is treated at Step 62 as a conventional e-mail and processed as normal typically by leaving it in the inbox for the recipient's consideration. Otherwise, a folder determination process is carried out at Step 64. The folder determination process validates the e-mail and its contents and analyses the XML schema present within the structured e-mail to determine an appropriate folder destination for the e-mail. This folder determination process is described in further detail later with reference to FIG. 4.

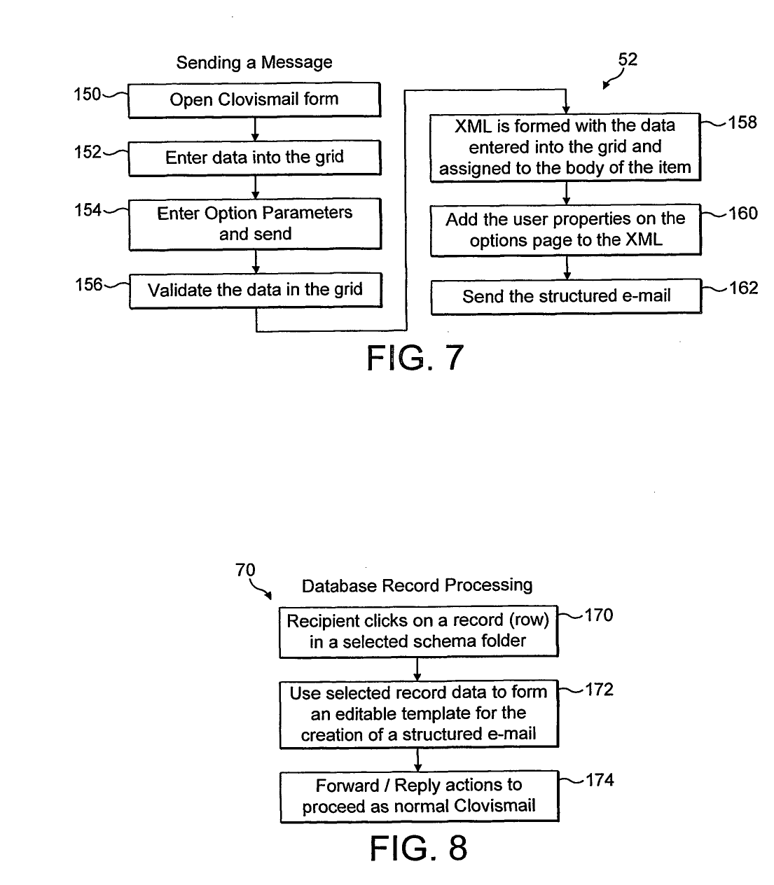

Having determined at Step 64 the destination folder for the structured e-mail, a create definitions process is carried out at Step 66. The create definitions process involves creating a database definition (similar to a presentation format) of the data (payload) contained within the received structured e-mail by parsing the XML e-mail content and thereafter storing that content in the designated destination folder to which the created definition has been applied. Typically, a definition is a set of column headings describing the meaning of the elements that make up a row in a grid of received information, as is described in detail later. Here it is to be appreciated that it is not the e-mail itself that is to be stored in the tabulated destination folder but rather the content of the e-mail. This create definitions process 66 is described in further detail later with reference to FIG. 5.

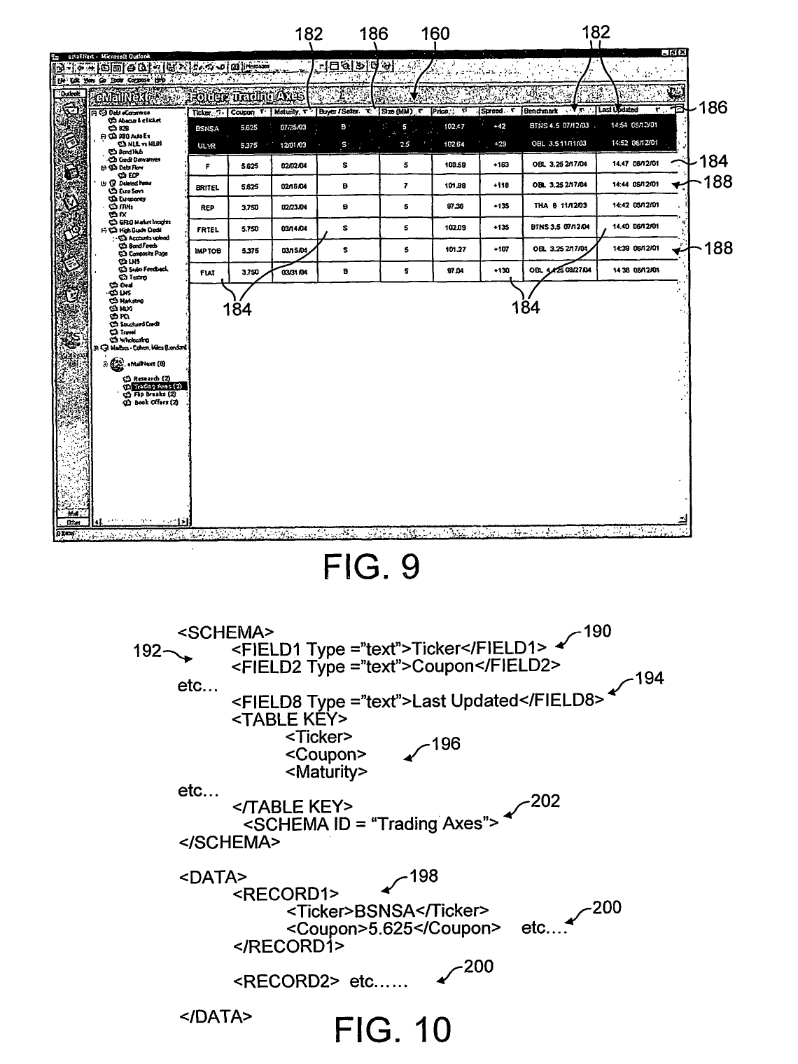

A received structured e-mail typically contains more than one set of items, the method 50 creates at Step 68 a database entry for the received data. The database entry is based on the data structure specified in the structured e-mail itself. Using a database in this way enables each of the separate entries (items or records) in the destination folder to be independently manipulated if required. Typically, each of these entries provides a single row in a matrix (table) of information as is also described later. Furthermore, the data stored here can be updated (overwritten) by newer data in this create/modify database representation step 68. This process 68 is described in further detail later with reference to FIG. 6.

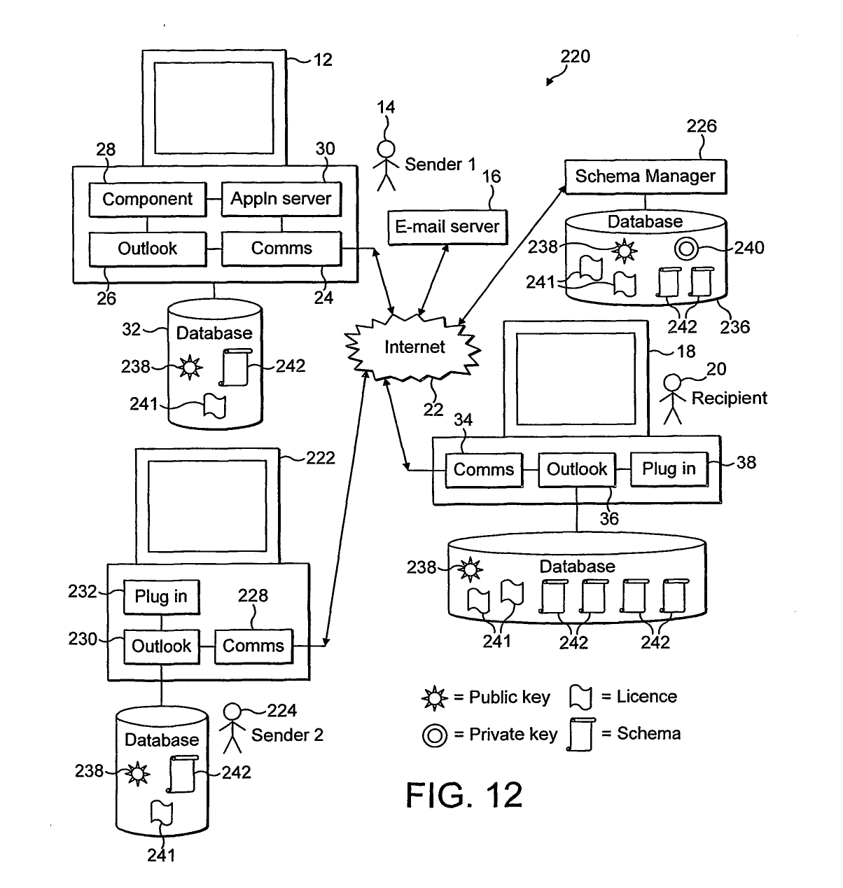

The method 50 continues with the optional database record processing at Step 70 of any of the individual items provided in the structured e-mail. Typically, this processing step enables a recipient to edit a previously stored data structure in the relatively easy generation of a new data structure which is to be forwarded onto other recipients. This processing step 70, which is only one of many possible database processing steps, is described in further detail later with reference to FIG. 8.

Once the individual items of the e-mail have been processed, the method ends at Step 72.

FIG. 2 also shows the steps that occur at the second computer 18 at the start of the method. The recipient 20 starts at Step 74 his local e-mail handling application module 36, e.g. Microsoft Outlooks. Then the local components of the e-mail handling application module 36 are initialised at Step 76 to configure the local e-mail handling application module 36 to handle any structured e-mails that it may receive. This initialisation process 76 is described in further detail below. Once complete, the next step is the receipt of an e-mail and the method 50 continues as has been described above in Steps 60 to 72.

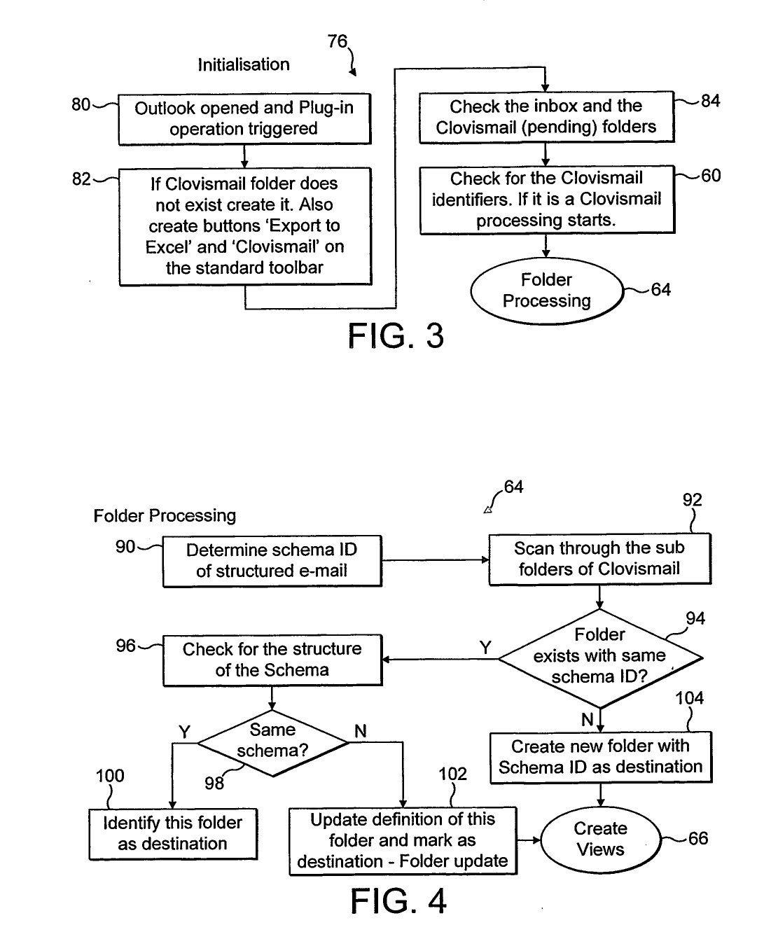

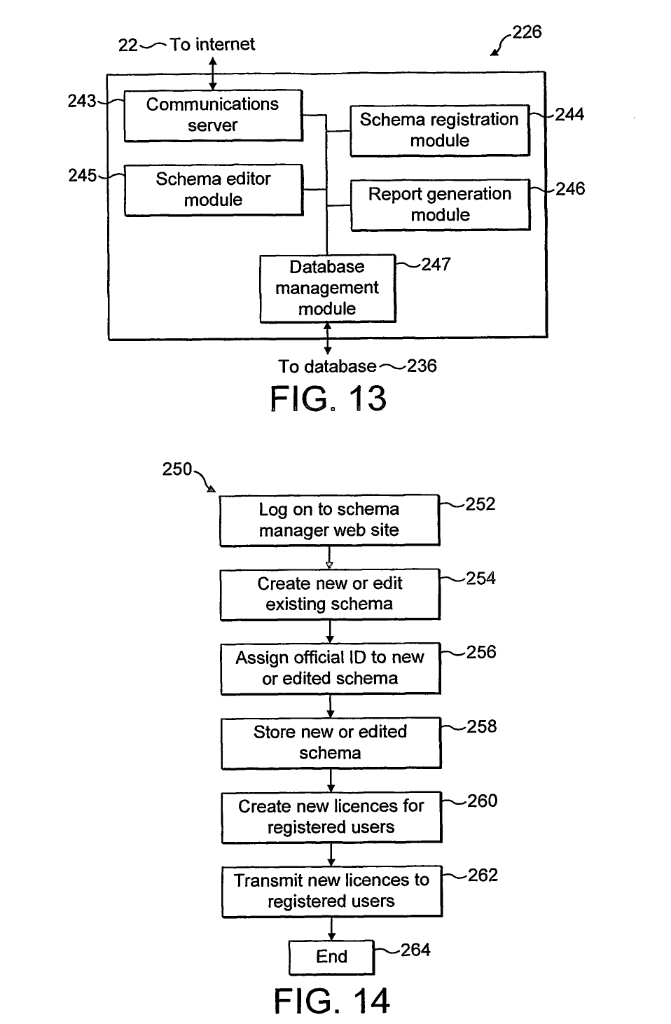

Referring now to FIG. 3, the initialisation process 76 is now described in greater detail. The process commences with the local e-mail handling application module 36 (Microsoft Outlook™) being opened at Step 80 by the recipient 20. The opening of this module 36, activates the plug-in 38 which determines at Step 82 whether there are any specific folders for storing Clovismail in the local e-mail handling application module 36. If there are not, then new Clovismail folders are created at Step 82. In addition, the interface (see FIG. 9 for an example) of the local e-mail handling application module 36 is adapted to provide processing options to the user specific to Clovismail. For example, new buttons are created such as ‘Export to Microsoft Excel™’ and ‘Clovismail’ on the interface's standard toolbar.

Finally, the initialisation process 76 is completed with a check being carried out at Step 84 for any previously received structured e-mails (Clovismails) which may have been received but not yet processed. The check is carried out in both the inbox and the Clovismail folder (pending Clovismails yet to be processed). This check covers several situations in which processing can be stopped such as when a Clovismail has been received and prior to processing it the local handling application module 36 has crashed thereby requiring rebooting.

FIG. 3 also shows Steps 60 and 64 of the method 50. More specifically, the check at Step 60 to determine whether the received mail is a Clovismail message can be carried out in a number of different ways. In this embodiment, it is carried out by checking for a Clovismail identifier within the text body of the structured e-mail. If the identifier corresponds to a predetermined identifier for Clovismail, then the folder processing at Step 64 commences. The predetermined identifier is recognised by checking for specific tags (XML tags in this embodiment), such as <Clovis></Clovis> tags. In the case of a partial message (where a message is provided over two e-mails), each part is additionally tagged with a unique identifier of the complete structured e-mail such that they can be associated together by the local e-mail handling application module 36 once received.

Referring to FIG. 4, the folder processing at Step 64 of the method 50 is now described in detail. At Step 90 the Schema ID is determined from the contents of the e-mail. Then the data within the text body of the e-mail is processed as described below.

Once the name of a schema (a Schema ID) has been read, the folder processing step 64 scans through at Step 92 the sub folders of the Clovismail main folder within the e-mail filing organisation of Outlook 36. Checks are carried out at Step 94 to determine if a sub-folder exists which identifies (i.e. names) the same schema. If a match is found at Step 94, then the structure of the schema contained within the structured e-mail is checked at Step 96 against the structure of the schema associated with the sub folder (this is conveniently provided by any of the items stored in that sub-folder). If it is the same schema as determined at Step 98, then the folder having the matching schema as the structured e-mail is identified as the destination sub-folder for that structured e-mail. If however, the schemas do not match as determined as Step 98, then this is a schema update e-mail and the definition of the folder is set to be updated at Step 102. This folder to be updated is marked as the destination sub-folder for that structured e-mail.

Returning to the check that is made at Step 94 to determine whether a folder exists under the same name as the schema name provided in the structured e-mail, if the answer is no, then a new sub folder is created at Step 104 and the read schema ID is used also at Step 104 to label the new sub-folder and identify it as the destination folder for that structured e-mail.

In both instances of updating the definition of an existing folders or creating a new folder, as is carried out in Steps 102 and 104, the result also requires the create definitions process at Step 66 to be carried out.

The create definitions process 66 is described in detail in FIG. 5. The process commences with the plug-in 38 parsing at Step 110 the XML of the body of the structured e-mail message. In this regard, many standard parsing techniques are known and these could be used. In this embodiment, the data structure provided within the structured e-mail is in the form of an XML tree and the required column names (for placing the data into a table format) are obtained at Step 112 by reading the nodes of the XML tree. Thereafter, a database definition is created at Step 114 based on the read column names. The thus constructed definition is then saved at Step 116 and then applied at Step 118 to the folder marked as the destination for that structured e-mail.

FIG. 6 shows the create/modify database representation process 68 in detail. The process commences with the data content of the received structured e-mail being stored at Step 130 in the database 40 under the Schema ID. As the data is now within a database environment, its elements such as data rows can be treated independently using conventional database management techniques. Therefore, each child item can be treated by the second computer 18 of the recipient 20 as though it had been sent separately by the sender 14.

The create/modify database representation process 68 continues with the plug-in 38 checking at Step 132 for any sender defined column grouping being provided in the e-mail. A sender defined column grouping enables the matching and replacement of a previously received item (row) of the data with the present one. In order to effect a replacement, the content of the fields of the item specified by the column grouping must be matched by the content in the corresponding fields of the previously received item. This process of mapping the values of the columns specified in the column grouping to look for duplicates is carried out at Step 134. When a match is found, the existing item is deleted and the new item is inserted at Step 136 in its place. It is also possible for the action to be that of just deletion of the current data when a match is found and, in this way, the sender 14 can delete specific data in the recipient's computer 18.

Whilst not explicitly shown in the figures, it is possible for each structured e-mail to include an expiry time and an indicator that the content of that e-mail should be deleted by the local e-mail handling application 36 when the expiry time has been reached. This allows items to self delete after a certain period of time thereby cleaning the content of the folder automatically for the recipient 20. It is even possible to associate the expiry time with each of the individual items described in the sent e-mail (typically as a new data field) such that when individual child items are created, they can have differing expiry times.

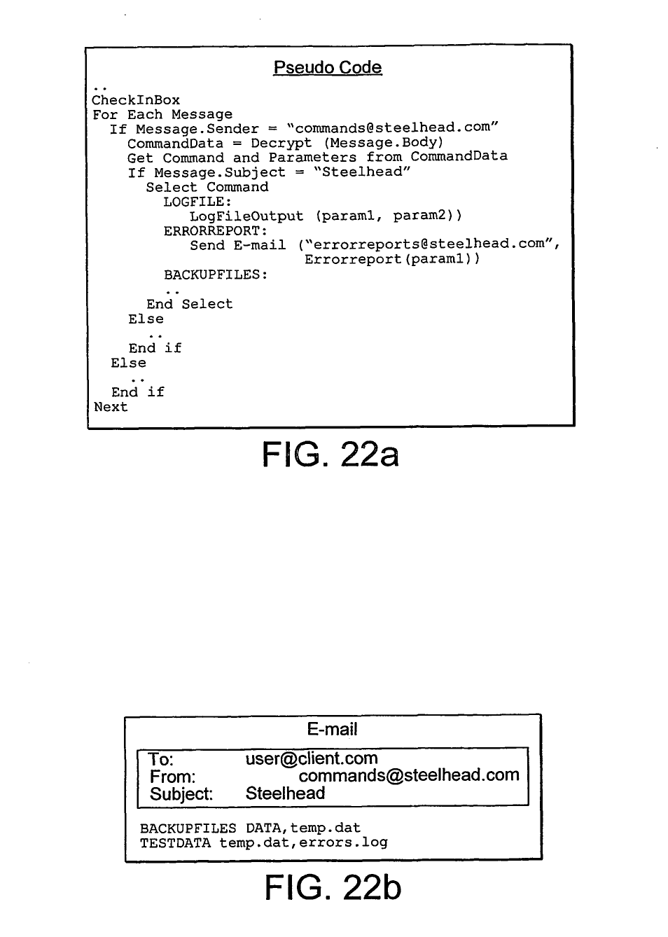

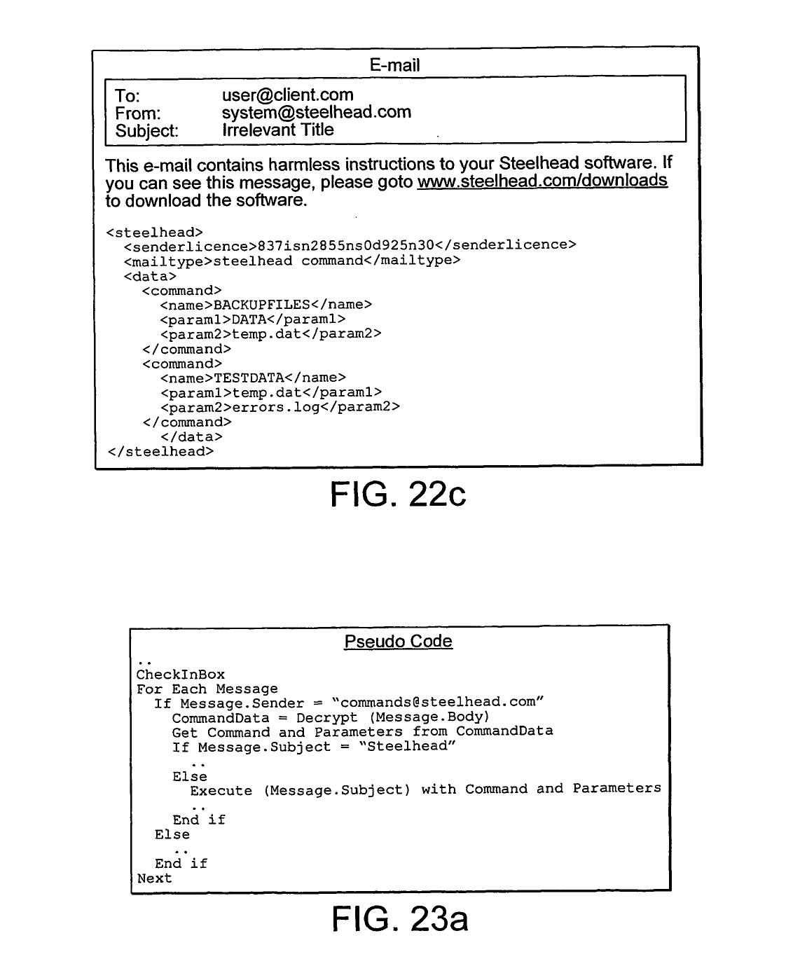

Referring to FIG. 7, the creating and sending of a message at Step 52 of the method 50 is now described in further detail. This procedure is designed to remove any requirement for the sender 14 to have knowledge of XML coding. Rather, the sender 14 can simply populate a form which gets converted into the appropriate XML code to describe the data structure and its associated content. This XML code can then be used to create the structured e-mail. More specifically, the procedure commences with the opening at Step 150 of a Clovismail form. This form (shown and described later in FIG. 17) typically comprises a grid for data entry and some items for parameter selection. The sender 14 then enters at Step 152 their data which his to be sent into the grid including the name of each column of the grid under which the data is categorised. Option parameters are then entered at Step 154 via an options page (shown and described later in FIG. 18) and sent to the component module 28 for checking. The component module validates at Step 156 the data which has been entered into the grid by checking their consistency and compatibility with the entered parameters. Validated data of the grid is then converted at Step 158 into XML code and is assigned to the body of the XML code. The user properties as specified in the options are thereafter added at Step 160 to the XML code. The XML code is wrapped in an e-mail carrier and sent at Step 162 as a conventional e-mail.

It is also possible by provision of the application server 30 at the sender for the required data to be obtained from a remote source such as a stock market via the Internet 22 or a dedicated communications feed and then the raw data used to populate the grid for data entry described above. In this way the sender can automate the supply of information to the receiver 20 and crucially provide a mass of data in an efficient manner, which also enables real-time monitoring of a plurality of stock prices for example.

Referring now to FIG. 8, the data record processing step 70 is now described. This step arises when a recipient 20 wishes to use an existing received schema as the starting point for sending a structured e-mail to another recipient. The step 70 commences with the recipient 20 clicking at Step 170 on one or more records (rows) in a selected schema folder. This is equivalent to opening a normal e-mail or otherwise accessing open or reply functionality in the local e-mail handling application module 36. Thereafter the selected record(s) data is used at Step 172 to provide an editable template for the creation of a structured e-mail. Once the content of the structured e-mail has been edited or is acceptable, the thus constructed e-mail can be subject at Step 174 to the normal forward/reply actions to proceed as normal Clovismail.

As described above, a user receiving a structured e-mail will have the data content automatically filed based on whether the schema definition matches a structure received in a prior e-mail message. On clicking on the appropriate folder, contents of any data within that schema are shown. The screen-shot set out in FIG. 9 exemplifies the views which are created for the recipient 20 in Outlook 36. Here the screen displays a folder 180 called “Trading Axes” (a bond markets term to highlight special offers) with eight fields 182 of data 184. Each field 182 is labelled with a column title 186 such that the user can readily compare the different items 188 (one per row) shown in the folder 180.

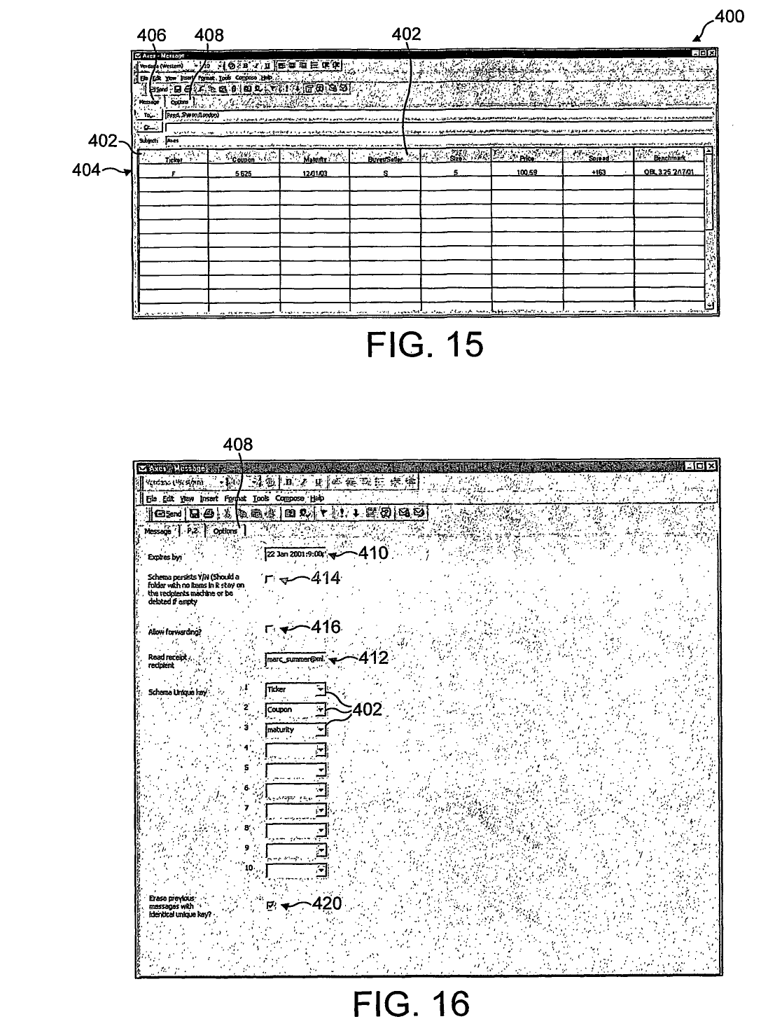

The folder shown in FIG. 9 is created by the sender 14 not the receiver 20. In this regard the XML code 190 used to create it is indicated in FIG. 10. As can be seen the code starts with a Schema definition 192 in which the types of data for each column are specified and thereafter the column heading are provided in a table key 196. In this particular case, the column headings are Ticker, Coupon, Maturity, Buyer/Seller, Size (MM), Price, Benchmark. The data 198, which populates the schema 192 is set out as items of the records 200 in the data section of the code 190. The received records are sortable/viewable just like conventional e-mail, i.e. by clicking on the column titles, the records are renumbered by that field. The schema ID 202 is also defined here.

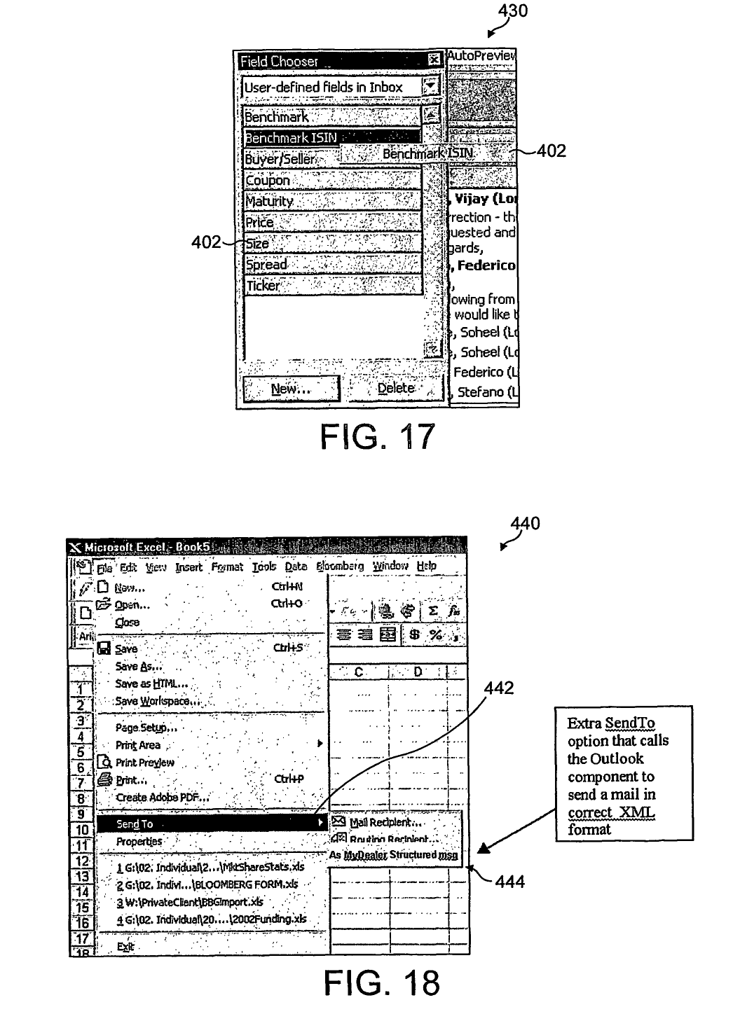

Referring now to FIG. 11, the way in which received data is made available to other applications 42 is described. Structured e-mail may be received from more that one sender 14 (two senders shown). These e-mails have to traverse a firewall 210 to be made available to the recipient 20. When the recipient's e-mail handling application 36 receives a structured e-mail, the individual data records are simultaneously viewed within the recipient's local e-mail handling application 36 as record tables and made available for use by other applications 42. More specifically, the data with the structured e-mail is exported as CSV, Excel, XML or any other standard data structure language into a separate file (not shown) in the database 40 on the recipient's computer 18 which is outside of their local e-mail handling application 36. As the raw data records are stored externally to the e-mail handling application 36 in the database 40, these can be simultaneously accessed by other applications 42 within the recipient's organisation. This is particularly important to the third embodiment of the present invention which is described later.

### A Worked Example of the Methodology of the Present Embodiment

The component module 28 (also referred to as the Steelhead Application) in conjunction with the local e-mail handling application 26 allows structured data to be sent via e-mail whilst retaining its structured form through the creation and recognition of “Structured E-mails”: This is performed in this example as follows:

i) The sender 14 has or constructs information they wish to communicate in a structured format, typically taking the characteristics of any two-dimensional table or list. For example the following table of data:

| A | B | C | D | E | . . . | . . . | . . . |
|---|---|---|---|---|---|---|---|
| R | O | W | 1 | | | | |
| R | O | W | 2 | | | | |

The component module 28 (provided in the sender's e-mail, spreadsheet or some other application) formats, and may encode, the structured data set as a text string that can be contained in the e-mail message.

Pseudo codification:
Schema name=“Gridder”
Data Structure:
   4 fields
   1^{st} Field named “A”
   2^{nd} Field named “B”
   3^{rd} Field named “C”
   4^{th} Field named “D”
   1^{st} Field data type=“text”
   2^{nd} Field data type=“text”
   3^{rd} Field data type=“text”
   4^{th} Field data type=“numeric”
Record 1:
   Field “A”=“R”
   Field “B”=“O”
   Field “C”=“W”
   Field “D”=“1”
   . . .
Record 2:
   Field “A”=“R”
   Field “B”=“O”
   Field “C”=“W”
   Field “D”=“2”
. . . etc

E-mail routing information is added so that the message behaves and is treated as a standard e-mail, and the e-mail is sent via standard e-mail paths.

A component (plug-in 38) at the recipient's computer 18 recognises the e-mail as a Structured E-mail and unwraps and restores the structured format of the data from within the E-mail. The view onto the data for the recipient 20 is similar to the traditional “inbox”, except that it will contain the original tabular structure that the sender 14 commenced with. No additional viewer is therefore needed. An example view for the recipient 20 is provided below:

| A | B | C | D | E | . . . | . . . | . . . |
|---|---|---|---|---|---|---|---|
| R | O | W | 1 | | | | |
| R | O | W | 2 | | | | |

b) Folders are created by the Application on the recipient's computer 18 using the following methodology:

i. An e-mail is detected by the plug-in 38 installed on recipient's computer 18 as a Structured E-mail by scanning the text string to ensure it adheres to the Application's requirements of a schema ID, data structure definition and data.

ii. The Schema name is read. In the following example=“Gridder”

Schema name = Gridder

| A | B | C | D | E | . . . | . . . | . . . |
|---|---|---|---|---|---|---|---|
| R | O | W | 1 | | | | |
| R | O | W | 2 | | | | |

Pseudo codification:
   Schema name=“Gridder”
   Data Structure:
      4 fields
   1^{st} Field named “A”
      2^{nd} Field named “B”
   etc. . . . .

iii. If a folder 180 with the Schema name is present, the e-mail is filed within that folder 180. In this example, if a folder with Schema name Gridder was present, the e-mail would be filed within that folder.

iv. If no folder exists for the specific Schema Name then a new folder 180 will be created in preparation to hold the data. In this example, the folder 180 will be named “Gridder”.

v. In all cases the folder 180 is now viewable on the recipient's computer 18 in their local e-mail handling application module 36 as part of the recipient's folder tree view:
└Inbox
└Sent Items
└existing folder 1
└existing folder 2
└Gridder

c) All new messages arriving at the recipient, regardless of sender, that are Structured E-mails and that have the same schema, are automatically filed in the same unique folder on the recipient's PC. In the above example, all Structured E-mails from any sender with a Schema name Gridder would be filed in the Gridder folder. One key advantage is that different senders 14 can all automatically file their messages into the same unique folder 180 on the recipient's computer 18.

d) Now that individual folders 180 for different data structures have been created, this allows similarly structured data to be grouped together. One key advantage here is that each record of data becomes a new row in the recipient's folder 180 even though only one original message was sent.

Therefore, continuing the above example, when the user clicks on the “Gridder” folder to view its content they see:

└Gridder

| A | B | C | D |
|---|---|---|---|
| R | O | W | 1 |
| R | O | W | 2 |

This view is constructed even though only one original e-mail was sent. A user is unaware that the data came in one e-mail message not two as the records in the data are now fully independent. As such, a recipient 20 can then sort data on any data item (first click ascends, second click reverses, i.e. descends). In this example, a recipient 20 clicking on the fourth field “D” could view data as:

(ascending sort on field “D”)

| A | B | C | D |
|---|---|---|---|
| R | O | W | 1 |
| R | O | W | 2 |

Or

(descending sort on field “D”

| A | B | C | D |
|---|---|---|---|
| R | O | W | 2 |
| R | O | w | 1 |

e) The recipient 20 does not need to clean up their folders 180 as whilst new data is inserted as described above, the sender 14 can also delete and update previously sent data. This methodology for this works as follows:
i. The sender 14 can add additional attributes to their message to allow previously sent e-mails to be deleted or updated similar to the “DELETE” and “UPDATE” operations in normal SQL.
ii. To update, the sender 14 configures the e-mail appropriately through some GUI (selection of a parameter for example) and then specifies which fields form the matching criteria. E.g. a user may specify that “Field C” and “Field D” are relevant in this matching criteria and therefore if any of the records sent with this 2^{nd} updating message contain information in “Field C” and “Field D” that matches any records in the recipient's inbox from the same sender 14, then the previous records will be deleted and the next content inserted. This is equivalent to a database SQL command of UPDATE WHERE “Field C” In ([list of field C values sent in this message], . . . ) AND Field D In( . . . , . . . , etc).
iii. To delete, the sender 14 configures a message appropriately and similar logic is applied. This is equivalent to an SQL-style “DELETE . . . WHERE” operation on the recipients folder.
   Pseudo codification for an update:
   Schema name=Gridder
   Record 1:
      Field A=“G”
      Field B=“H”
      Field C=“W”
      Field D=“1”
      . . .
   Record 2:
      Field A=“I”
      Field B=“J”
      Field C=“W”
      Field D=“3”
   . . .
   Field match: Field C, Field D
   Example:

Therefore if the recipient's inbox previously looked like this:

Schema name = Gridder

| A | B | C | D | . . . | . . . | . . . |
|---|---|---|---|---|---|---|
| R | O | W | 1 | | | |
| R | O | W | 2 | | | |

Normally the new e-mail would be filed as two new rows to generate a four row inbox looking like:

Schema name = Gridder

| A | B | C | D | . . . | . . . | . . . |
|---|---|---|---|---|---|---|
| R | O | W | 1 | | | |
| R | O | W | 2 | | | |
| G | H | W | 1 | | | |
| I | J | W | 3 | | | |

However, as the Field match criteria were set to “Field C” and “Field D”, then if any records match either “W,1” or “W,3” in fields Field C and Field D respectively, then the previous records would be deleted and the new records inserted, in effect an update. That is, the new inbox would look like:

Schema name = Gridder

| A | B | C | D | . . . | . . . | . . . |
|---|---|---|---|---|---|---|
| G | H | W | 1 | | | |
| R | O | W | 2 | | | |
| I | J | W | 3 | | | |

To explain this, the first record in the update message (G,H,W,1) matched the original first record in the recipients inbox (R,O,W,1) in the last two fields (Field C and Field D)—therefore R,O,W,1 was deleted and G,H,W,1 was inserted. The second record in the update message (I,J,W,3) did not match any content in the recipient's inbox and therefore was appended as normal.

Whilst the first embodiment has described the use of a license to authenticate the sender to the recipient, it is not necessary to provide such authentication. This is particularly true if there is no central authority to provide such licenses to the senders.

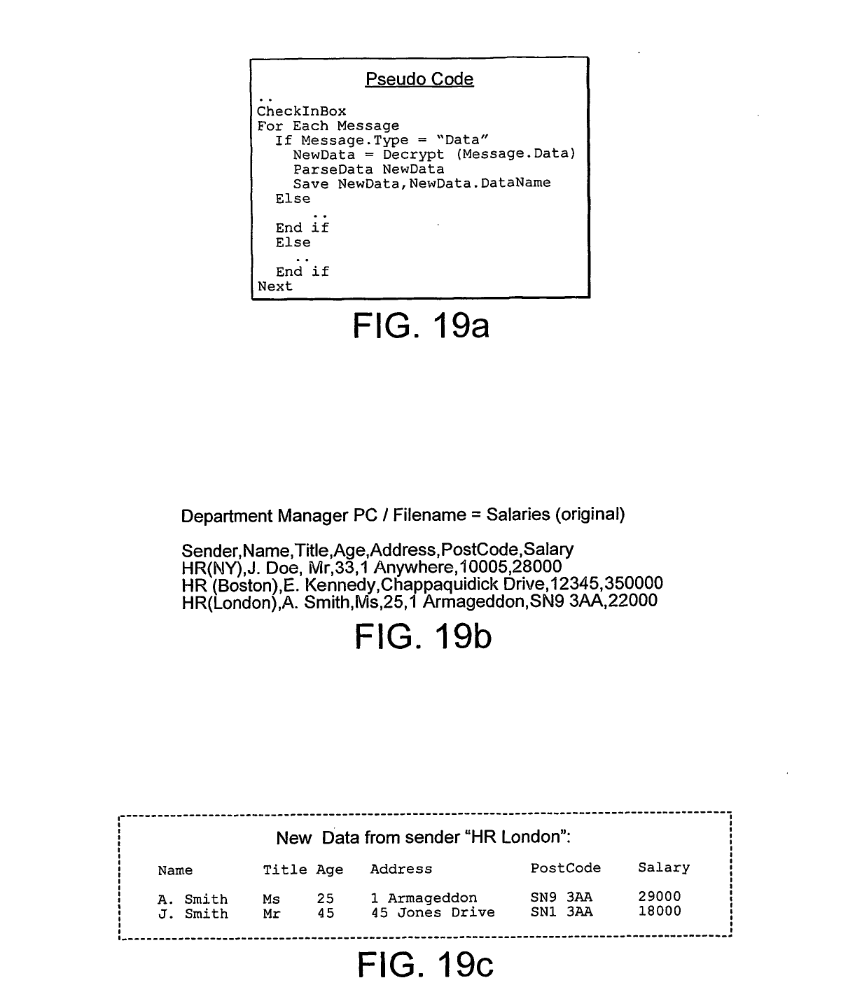

A second embodiment of the present invention is now described with reference to FIGS. 12 to 20 of the accompanying drawings. The second embodiment has much in common with the first and therefore for the sake of brevity, the following description is directed to the differences between the two embodiments and any common features which have not been fully described in the first embodiment.

The main difference between the first and second embodiments relates to schema control. The second embodiment facilitates a more defined use and handling of different schema for the data structures within the structured e-mail. Whilst requiring slightly more effort on behalf of the sender and recipient, the benefits are significant as is explained below.

The second embodiment addresses several problems which may arise out of use of the first embodiment. These include the problem of errors occurring in a structured e-mail's content such as schema and headers, which would itself result in the generation of multiple folders even though data should be co-mingled. Also, there is no control over the generation and use of schema and so it is possible for many more schema to be created than are actually required leading to folder chaos at the recipient's computer 18. In addition, it is not possible to stop non-authorised members in participating in the addition of information to a recipient's folders if they know the basic data structure and name used for a particular folder. Furthermore, data transmissions can be hacked as e-mail is not a secure mode of communication.

The schema control provided by the second embodiment achieves the following:
1) schemas with errors are not set up as new folders, but rather can be recognised and returned to sender as bad data;
2) non-consortia members (such as members who are no longer authorised) cannot send data to folders they do not participate in, even if they know the name and structure of the data stored in the folder;
3) secure transmission of information (for example preventing data hacking on the internet) is ensured by use of encryption and decryption techniques;
4) consortia members cannot read each others content (unless desired!);
5) schema structure updates can be managed seamlessly across large numbers of users;
6) sophisticated structures (dynamic links between folders) can be created, for example Bond.Hub axes linked by ticker to Bond.Hub research (Bond.Hub is an existing industry consortia set up between eight bond dealers (ML, CSFB, GS, JPM, Lehman, MSDW, SSB, UBS). All dealers have integrated their websites (including single logon and password) with a view to providing a single website that combines their research articles and also their trading axes. Axes are typically like “today's special offers” where a dealer wants to promote a certain bond because they feel it is worth trading and they are offering a good price. Because all the dealers are promoting their best prices, clients want commingled lists of bonds across all dealers.)

More specifically, referring to FIG. 12, a system 220 in which the second embodiment of the present invention is deployed is shown. The system 220 comprises the first personal computer 12 of the sender 14 (herein after referred to as sender A), the remote e-mail server 16, the second personal computer 18 of the recipient 20 and the wide area communications network 22 such as the Internet connecting together each of the above, as has been described above in the first embodiment. In addition, the system 220 comprises a personal computer 222 of another sender (Sender B) 224 and a schema manager 226 for managing and controlling the use of schema, which are both connected to the Internet 22.

Sender B's personal computer 222 comprises three software modules, which function to create and send structured e-mails to the recipient 20 via the e-mail server 16 in accordance with this second embodiment of the present invention. A communications module 228 handles the communications functionality and is functionally equivalent to the communications module 24 of the first embodiment. A local e-mail handling application 230 manages e-mail creation and co-operates with the communications module 228 to send out recently recreated structured e-mails. A plug-in module 232 configures the local e-mail handling application 230. The plug-in module 232 works in conjunction with the e-mail handling application 230 to ensure that the content of a structured e-mail is in the correct format to be recognised by the receiver and processed accordingly. The communications module 228, local e-mail handling application 230 and the plug-in module 232 are functionally equivalent to the corresponding communications module 24, the local e-mail handling application module 26 and the component module 28 of the first computer 12.

The personal computer 222 is also provided with a local database 234 for storing information regarding content of structured e-mails, which are to be transmitted as well as other local information.

The schema manager 226 is also provided with a local database 236, which stores a public key 238 and a corresponding private key 240 for use in sender/recipient encryption techniques. The public key 238 is distributed widely amongst registered recipients 20 and senders 14, 224. These public keys 238 are used to decrypt licences 241 which are created by the schema manager using the private key 240. The licences 241 contain the schema ID, the actual XML for the schema itself, and an identification of the sender. The actual techniques are standard public/private encryption techniques, which are well known to the skilled addressee and so are not described further herein. The schema manager database 236 also stores a plurality of schema 242 for use by senders and recipients.

Whilst the above describes the use of many public to one private key 238, 240 for creation and decryption of licences, there are many other a viable alternative encryption and distribution techniques which can be used as will be apparent to those skilled in the art.

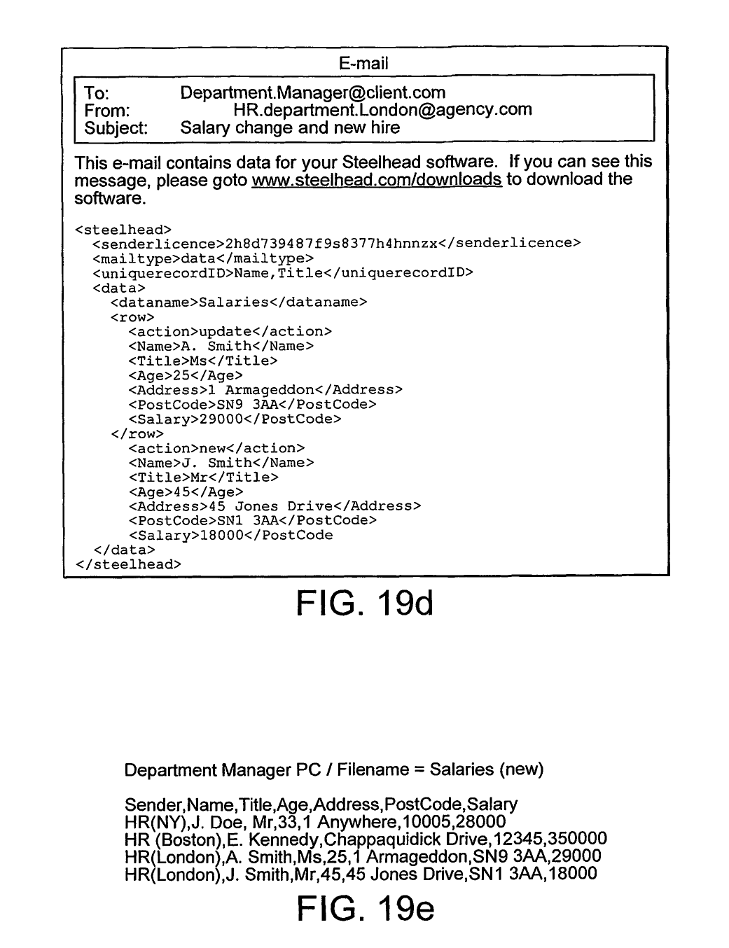

Referring now to FIG. 13, the structure of the schema manager 226 is described. The schema manager 226 comprises a communications server 243 which hosts a website for user access to all of the services provided by the schema manager 226. The communications manager 243 provides access to a schema registration module 244, a schema editor module 245 and a report generation module 246. The schema registration module 244 handles the task of registration of new schema and members of its associated consortia together as well as associating each new schema with a unique schema identifier (ID). This module is also responsible for the generation of encrypted licences for registered senders using the private key 240. The schema editor module 245 provides the services required for an authorised member of a consortium to edit or create a new schema 242. In this regard, the user does not need to know how to program in XML, but rather the schema editor module 245 simply enables them to create and edit a graphical representation of a view, which would be presented the recipient 20 in their in-tray. This view is often a simple table which when finalised is readily convertible into XML automatically. The report generation module 246 can analyse the usage of various schema 242 and other data to produce reports for consideration by registered members of a consortia. These reports can be sent via e-mail to the intended recipients via the communications server 243.

The services of the schema manager 226 can facilitate the setting up of complex structures. For example, the schema editor module 245 provides a simple way of linking data between registered folders: e.g. consider a price folder and research folder with a data link based on the Ticker field present in both folders:
Bond prices folder (Ticker, Coupon, Maturity, etc.)
Research (Headline, Ticker, Sector, Author)

The plug-in 38 on the recipient's computer 18 would then allow certain enhanced actions to be implemented. For example, right clicking a ticker in the Bond Prices folder could pull up a menu of related research headlines (same Ticker) drawn from the Research folder.

The above-described modules of the schema manager 226 all require access to the database 236. A database management module 247 is provided in the schema manager 226 to control and enable that access.

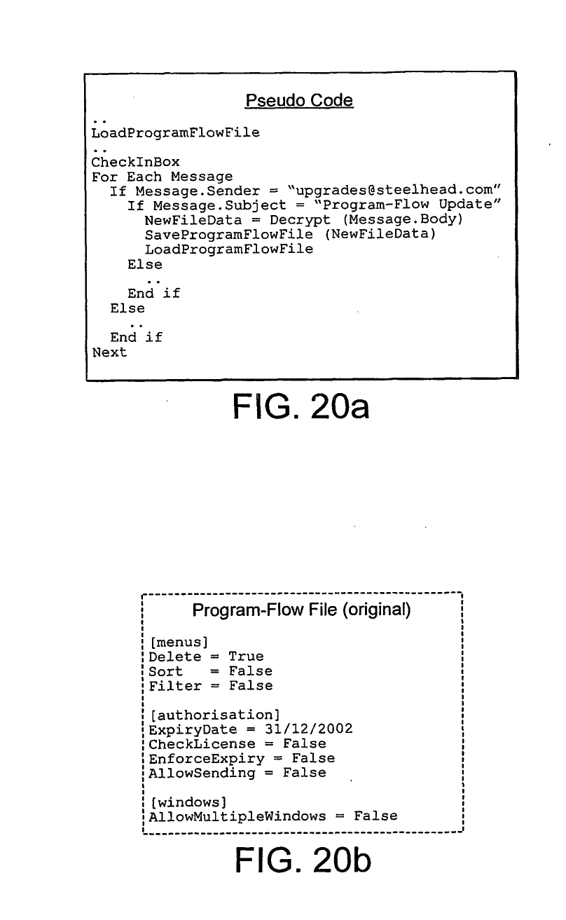

In order to use the system 220, it is necessary for the senders 14, 224 and recipients 20 to register with the Schema manager 226 and set up their schema. This set up process 250 is now described with reference to FIG. 14. The process 250 starts with a sender logging on at Step 252 to a web site (not shown) hosted by the communications server 243 of the Schema manager 226 for management and registration of schema 242. Once the sender has registered and has been accepted by the provision of an encrypted licence (not shown), they have access to the Schema editor module 245 which provides them with the ability to create or edit at Step 252 new or existing schema 242 for data that they want to send in a structured e-mail. This schema 242 can be used across multiple end users, which together form a consortium who can all use the same schema 242. This process of allowing consortia to create schema advantageously eliminates any need to upload client lists to the central schema manager 226. Furthermore, it enables a control report of which senders received which content to be generated by the report generation module 246 if required.

Once such a new or edited schema 242 has been created, an official identifier (schema ID) is assigned at Step 256 to it by the schema registration module 244. The new or edited schema 242 is then stored at Step 258 within the schema database 236. Then new licences 241 are created at Step 260 for each of the registered members of the consortium who will have access to this schema. Having created the required data, the licences 241 for this schema are transmitted the registered users (senders) at Step 262 together with the schema 242 and its unique ID itself. The public key 238 is transmitted freely to and used to decrypt the encrypted licence for the registered sender which can be used to authenticate the sender to the recipient. The set up process 250 then ends at Step 264.

The way in which the thus created schema 242 and the licence 241 is used in a method of the sending and processing of a structured e-mail is very similar to that described in the first embodiment, in particular with reference to FIGS. 2 to 8. However, there may well be more situations where the Clovismail folder is used and needs to be checked at Step 84 of the initialisation process 76 for pending e-mails. For example, when a valid licence of a sender has not yet been received and so the Clovismail from that sender has been placed in the Clovismail folder until a valid licence is received.

Also, the folder processing step 66 now includes in it checking at Step 90 the validity of the received e-mail. These checks include decrypting the sender's licence using a public Clovismail decryption key to see if it decrypts to a valid set of information describing the sender and the content of the e-mail, determining if the data conforms to the schema contained within the licence, the digital signature of the structured e-mail message is valid, and determining the checksum of the encrypted e-mail to ensure it has not been altered. If the licence is missing or invalid, then the e-mail is stored in a Clovismail folder for later processing rather than being allowed to be co-mingled with other data.

The schema ID is determined at Step 90 from the licence of the sender (created by Clovismail on registration of the sender to these services) which will typically contain a reference to the name of a schema (a schema ID) which has been used to organise the data (payload) contained within the structured e-mail.

A further difference from the first embodiment, is that in the process 52 of creating and sending a structured e-mail, adding at Step 160 the user properties to the XML message can also include adding a digital signature to the data. The digital signature together with the data can be encrypted using standard encryption techniques. This would require the use of standard decryption techniques at the recipient only once the steps of steps of determining that the e-mail is a Clovismail and determining the folder location, and creating the database definitions of the content to be stored in the database had been carried out. When the data is stored in the database at step 130, the data can be stored as recordsets, namely rows of data in accordance with the database definition for the folder.

The use of licences 241 to authenticate senders also serves to provide an error detection and action function in the present embodiment. For example, where the schema ID of an incoming Clovismail matched that of an existing structure indicating an addition of data to an existing folder was required, but the schema of the received Clovismail was found to be different to that associated with the existing folder, this would indicate and error in the Clovismail. This could result in the Clovismail being returned to the sender 14 with a description of the error.

Other important features of the present embodiment are now described below together with further explanation on some previously described features.

Records (each record has its schema built into the message) can be forwarded to other recipients in their own structured e-mail. Upon receipt, the e-mail is analysed and the record causes either a new folder to be created or grouping of the record with other records of the same schema, if the schema is already in use on the recipient's computer.

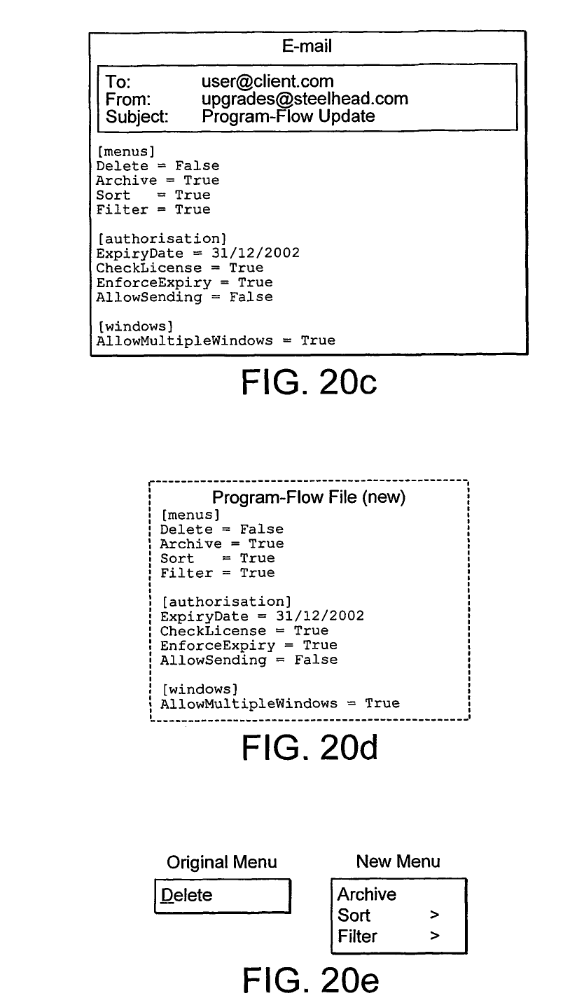

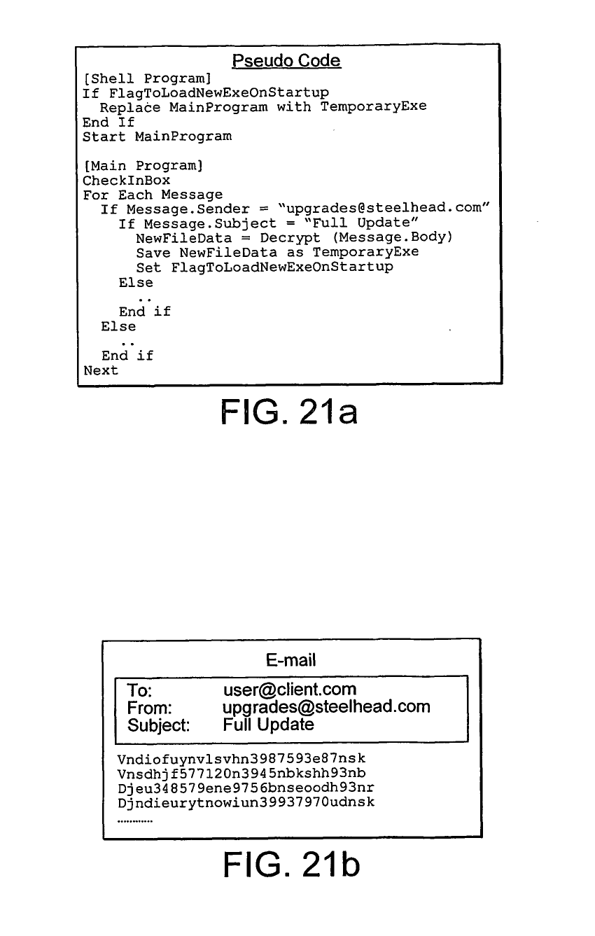

Senders 14, 224 can originate new messages and schema by completing a spreadsheet type grid (which replaces the normal new mail window and is generated automatically from the component module 28) as shown in FIG. 15. As can be seen, the spreadsheet type grid 400 comprises fields 402 across the top (one filed per column) and records 404 going down the page (one record per row). On pressing a send button 406, an XML message is automatically generated. E-mails are created with the body of text being replaced by XML commands that can generate a grid, which a sender can populate with data which is also included in the body of the e-mail. An options part of the message (controlled by selection of an options tab 408) allows the sender 14, 224 to specify a unique key as shown in FIG. 16 and described later. Also in other embodiments, messages can be created directly from Microsoft Excel™ spreadsheets, with a new message being called up based on a selected set of cells, with the options part of the message allowing a sender 14, 224 to specify a unique key. In this case, the data is passed directly from Microsoft Excel™ into the component module 28 in a conventional manner by use of APIs (Application Program Interfaces) or custom grids, etc.

In the present embodiment, a super-schema is provided to control overall features of all communications with certain “super-parameters”. This is controlled from the “Options” tab 408 in the generating new mail section of the local e-mail handling application 36 which is shown in FIG. 16. The super-parameters of this embodiment are listed and described below:
a) An identifier in the text body of the structured e-mail that describes the message as a component message, and hence assists in depositing the message into a Clovismail folder and not the regular e-mail folder;
b) Each record has an “Expires by” feature 410 (in this embodiment defaulted to 24 hours) to automatically delete old records and “self-clean” the folders.
c) Each record has a specified “Read receipt recipient” feature 412 (e-mail address) to send the read receipt to a recipient who is not the sender (e.g. if the original e-mail was computer generated, but a salesperson would like the read receipt). Read receipts are themselves in XML format and follow the schema of the original message (but titled as ReadReceipts: XXX—where “XXX” is the original name of the schema sent). The default for this field is the sender 14, 224;
d) The overall schema 242 has a “Schema Persists (Yes/No)” feature 414 to determine whether a schema 242 without any records (say, if have all been deleted after expiring after 24 hours) still exists as an empty folder or is automatically cleared;
e) The schema 242 has an ‘Allow forwarding (Yes/No) by record’ feature 416 which allows senders 14, 224 to specify certain items they do not want forwarded to other recipients 20 by the first recipient 20.
f) Each schema 242 when defined can be set to have a unique key 418 that is a combination of the fields 402 of the schema 242, the sender's e-mail address, read receipt recipient and the subject/schema title. This is shown in FIG. 16 by the series of drop down boxes (up to ten fields can be combined in this embodiment) to form a unique key. The check box “Erase previous messages with unique key” 420 then allows the sender 14, 224 to delete previous e-mails they have sent, thereby allowing updates via a Delete & Insert operation.

Any message sent is copied to a folder called “Previous schema” that allows the recipient to create new messages in a set schema format by calling on the schema of a previous record and not generating the data structure/schema from scratch for subsequent messages.

Within any given schema, the complete recordset (list of messages in that schema) can be exported to Microsoft Excel™ or a comma delimited file. In this case, the present embodiment has the ability to copy a Microsoft Excel™ list into a new mail writer detailed as shown in FIG. 15. The list is provided in standard grid format (for example, five columns×eight rows) with no blank lines etc.

As with conventional e-mail, structured e-mail messages can have multiple recipients.

Messages when clicked, open up as would a normal regular e-mail—this is useful in the case of large records where in the folder view, only a truncated view of a field's contents are shown (e.g. “Lower interest rates will . . . ” could be expanded when the record is opened to view the whole text).

In the user's Clovismail—inbox/folder view, columns can be re-ordered using drag & drop and a field chooser type view 430 (as shown in FIG. 17) to add or hide columns that the sender 14, 224 has sent, but the recipient 20 is not interested in.

Therefore, this allows customisation of the recipient's view of the data that persists for new records matching that schema sent at a later date. The field chooser 430 is shown in FIG. 17—in this case the figure shows the recipient 20 dragging in the extra field “Benchmark ISIN” 402.

The body of each structured e-mail sent preferably starts with some untagged free text message saying “To decode this message download this component (plug-in) from www . . . ”. This is useful in the case of sending the content to recipients 20 who do not have the plug-in 38 installed as it informs them how to get the plug-in and the message is deposited in their inbox. If a recipient does have the component, as the initial message is untagged, it is simply ignored and the message is filed as described above.

Referring now to FIG. 18, the present embodiment can provide a spreadsheet plug-in 440 to generate new e-mails directly from the spreadsheet that fit the schema requirements and can be converted to textual characters for embedding within the structured e-mail itself, rather than the conventional method of creating a new mail with the Excel™ file as an attachment. As can be seen, the sender 14, 224 would simply select the ‘send to’ drop down option 442 and select the ‘as mydealer structured message’ option 444, to achieve this.

The above-described read receipts for messages feature is sent at the point of opening the folder in which the messages reside—not later when the actual individual records themselves are opened. For example, if a user had a folder/schema called “Trading Axes” with five new records sent to it, the folder would display in bold: Trading Axes (5). On clicking the folder to view any of the items—all records should be marked as read and one read receipt per key omitting the user-defined part of the key (see options section of a new mail message, the key is formed by combining: sender's e-mail address, read receipt recipient and the subject/schema title and any user specified key records) is generated at this point. It is assumed that opening a folder equates to reading ALL content of ALL messages. This is because individual records are not likely to be opened in many cases—only read from the folder view.

The present invention is now described with reference to a third embodiment. This embodiment is similar to the first and second above-described embodiments in that it uses simple well known e-mail messaging techniques but embeds control commands as well as data within the text body of the e-mail to effect an action at the recipient's computer. Much of what has been described in relation to the first and second embodiments is applicable to the present embodiment especially when it is being used with structured e-mail. Therefore, for the sake of brevity the following description will be directed at the differences between these embodiments.

The third embodiment is used for implementing a remote control function via e-mail messaging or even instant messaging as is described later. The messages as in the first embodiments advantageously obviate the need for attachments. There are several actions which can be effected by the use of an e-mail according to the present embodiment including:
a) updating a sender-defined database on the recipient's computer;
b) updating the functional capability of the applicant's program used with the present invention;
c) updating the executable code of the applicant's program;
d) issuing commands to the applicant's program; and
e) issuing commands indirectly to other programs.

Each of these above-listed actions can be implemented using structured e-mails of the first and second embodiments or even unstructured e-mails, with recognisable characteristics. Each of these actions is now generally described below and is illustrated with reference to a following more detailed specific example.
a) Updating a sender-defined database 40 on the recipient's computer 18 involves providing a “Program-Flow” file (not shown but a text file within the Steelhead Application 36,38 on the recipient's computer 18) which instructs the Steelhead Application 36,38 (see FIG. 11) on how to deal with data contained in e-mails. Consequently e-mails containing data are identified by the Steelhead Application 36,38 and the data contained within the e-mails are automatically exported out of the recipient's e-mail application as CSV, Excel, XML or any other standard data structure language into a separate database file (not shown) on the recipient's computer 18. Similarly, new data contained within new e-mails can automatically update or replace existing data in such database files on the recipient's computer 18.
b) Updating the functional capability of the Steelhead Application 36,38 is possible. In this case certain features (e.g. menu items) are designed and coded in the originally distributed program executable (plug-in 38), but only operate if appropriate flags appear in a Program-Flow file, which can be readily updated via a structured e-mail as has been described above. The consequence of this is that from receipt of the upgrading e-mail, flags within the Program-Flow file are changed and the recipient sees, for example, new menu items, giving access to new commands (e.g. filtering, sorting, archiving, data exporting . . . ).
c) Updating the executable code of the Steelhead Application 36, 38 involves defining an e-mail as a ‘Command’ e-mail and a command line (encrypted) is contained in the body of the e-mail. The new version of the program (executable code) is encrypted into alphanumeric format, and sent as a Command e-mail. This is decoded on receipt and saved to disk, to replace the previous version of the program, and is run the next time the Steelhead Application 36, 38 is started.
d) Issuing commands to the Steelhead Application 36, 38 involves providing a command line (encrypted) within the body of the e-mail. The Steelhead Application 36, 38 identifies the command line as intended for the Steelhead Application 36,38 and will run that command line on receipt of the e-mail.
e) Issuing commands indirectly to other programs/applications 42 is similar to the process described above in section d). An e-mail is defined as a Command e-mail containing a command line (encrypted), and the program/application 42 to which it pertains, is specified in the body of the e-mail. The Steelhead Application 36,38 identifies the command line as intended for another program/application 42 and passes that command line on to the appropriate program/application 42.

### DETAIL EXAMPLES OF ACTIONS (a) TO (e)

a): Remote Updating of database Via E-mail

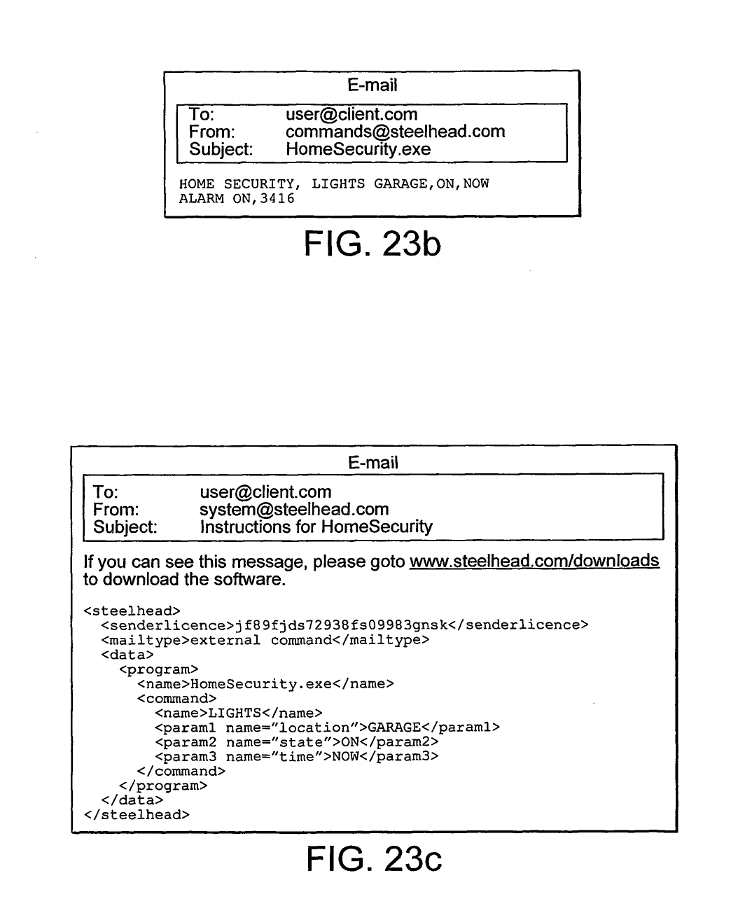

The Program-Flow File describes how the data contained within an e-mail is treated. The pseudo-code provided in FIG. 19a illustrates the process.

### Example

Data exists on “Department Manager's” PC in a file called “Salaries” to help Department Manager track the details of temporary staff hired by different agencies around the world. For example, the original file may be shown in FIG. 19b.

The file is to be updated by HR Department in an employment agency in London “HR London” to inform the Department Manager of both; an increase in salary for Ms A. Smith and the fact of a new hire of Mr. J. Smith. The data for that updating is shown in FIG. 19c.

This data is embedded by HR London in a structured e-mail to be sent to Department Manager as can be seen from FIG. 19d.

The Steelhead Application on Department Manager's PC recognises the e-mail, extracts the data and adds the data to an external data file, in this example the e-mail changes one record and adds one record to the existing CSV file on the Department Manager's PC called “Salaries”. The file has now been automatically updated and now as shown in FIG. 19e.

This data can now be shared by any application 42 running on the same network as the Department Manager's computer, for example both a spreadsheet calculating the annual cost of all temporary staff and a map plotting the location of all hires. So the effect of the one e-mail is to “update” the data for one or several applications.

b): Remote Switching On and Off of Pre-programmed Features

The original Program-Flow File is replaced, as a result of receiving an e-mail, with a new Program-Flow File. The pseudo-code shown in FIG. 20a illustrates the process.

### Example

FIG. 20b shows a potential Program Flow file on the recipient's computer 18 for implementing this action.

An e-mail as shown in FIG. 20c is received by the recipient 20 updating the Program-Flow. The Program-Flow file is then updated to that shown in FIG. 20d on the recipient's computer 18.

As a consequence, when the Application program is opened the Right Hand mouse click menu would have changed as illustrated in FIG. 20e, now giving access to new features.

c): Remote Updating of Program Code

The original exectuable (not shown) is replaced, as a result of receiving an e-mail, with a new executable. The pseudo-code shown in FIG. 21a illustrates the process.

The e-mail which instructs this remote updating is shown in FIG. 21b.

The program is instructed to replace the entire code of the executable with the new code contained within the e-mail.

d): Remote Issuing of Commands to the Applicant's Program

Commands, such as turning on a logfile or sending an error report, can be executed as a result of receiving an e-mail. The pseudo-code set out in FIG. 22a illustrates the process.

### Example

A sample e-mail with a command instruction to the Steelhead Application to back-up data and to send an error log back to the applicant (Steelhead) is shown in FIG. 22b.

This could also be achieved by a structured e-mail (see FIG. 22c), the structured part being normally encrypted (to prevent tampering):

The Steelhead Application recognises the command as intended for itself and executes a back-up and sends an error log.

e): Remote Issuing of Commands to Other Programs

A command for another program can be contained in an e-mail, either structured or not. The pseudo-code shown in FIG. 23a illustrates the process.

### Example

A sample e-mail with a command instruction to another application is shown in FIG. 23b, in this case a Home Alarm system, to turn on lights in the garage

This could also be achieved by a structured e-mail as shown in FIG. 23c, the structured part being normally encrypted (to prevent tampering).

The Steelhead Application recognises the command as intended for the Home Security System and passes a command line to the appropriate API to instruct the Home Security System to turn on the garage lights.

The present third embodiment of the present invention has a major advantage in that the absence of any attachment to the e-mail means that there are no firewall problems, there is no virus risk and no action is required by user for the action to be carried out (e.g. opening the attachment as in the prior art). This provides true remote control by the sender.

The present embodiment also has the following specific advantages:
Updating a sender-defined database on the recipient's computer is carried out by using standard e-mails, and therefore single or multiple senders can use e-mail to keep a database up-to-date on a recipient's computer without the recipient needing to set up rules and/or define the database. This would normally need a separate file attached to the e-mail or would rely on a recipient-defined database where the recipient has set up rules to run a parsing program to reconstruct structured data from the unstructured text of an e-mail.
Updating the functional capability or the executable code of the recipient's program (plug-in 38) used with the present embodiment would normally require a user-activated download and reinstallation. However in the present embodiment updates received by e-mail and are transparent to the recipient. Each recipient may have a different and changing feature profile, while having the same version of the program.
Issuing commands to the recipient's program (plug-in 38) or indirectly to other programs 42 would normally need a direct network link, but the present embodiment uses existing e-mail links.

Possible applications/uses of the above described five different actions (a) to (e) of the third embodiment are listed below according to action:
a) The updated database could be any data structure or content defined by the sender(s). The use of this is as broad as is the use of data. Some examples (not exclusive list):
   Pricing (e.g.: different Brokers updating bond prices and availability for clients);
   Listings (e.g.: members updating membership directories with various associations);
   News (e.g.: Legislators updating policies, codes and rules with relevant lawyers);
   EDI functions (e.g.; manufacturers updating pricing and availability information with retailers);
   Management information (e.g.: Sales people updating pipeline and client status for management teams).
b) To upgrade the program immediately via e-mail, whenever commercial or other considerations dictate either i) on a user-by-user basis or ii) to all users, and either i) on a feature-by-feature basis, or ii) a complete upgrade. Examples of use (not exclusive list):
   To respond speedily to a user's request for a “new” feature;
   To turn on and off selected features based on client payments;
   To increase gradually the complexity of the product to “educate” the user;
   To reward users with new resources or credit (e.g. levels in a Game, time to run the program, quantity of download allowed or amount of processing allowed).
c) As b) above to update the whole executable code, although not usually practical for a feature-by-feature or user-by-user basis.
d) To command the recipient's program (plug-in 38) to run certain routines. Examples of use: (not exclusive list):
   Remote control of authorisation and licensing;
   Log-file and error-report collection.
e) Control of other applications 42 by e-mail, by authorised senders and by their clients. Examples of use (not exclusive list):
   Help-desk trouble-shooting;
   Distributed idle-time research programs;
   Adding resources or credit to maintain other applications running;
   Remote control by client to manage other virtual or physical applications such as burglar-alarms, appliances, answer-machines, lights (assuming relevant hardware present).

All three embodiments have been described in the context of e-mail and this is the presently preferred medium. However, it is also possible to extend the present invention and the above described embodiments to use instant messaging as the communications medium for conveying the structured data and/or the remote control instructions. The skilled addressee is well aware of how Instant Messaging (IM) works. For example, further details regarding the functionality of IM are provided at http://computer.howstuffworks.com/instant-messaging/htm. Accordingly, a Clovismail IM plug-in would be provided at the sender and recipient and would interact with an IM handling application. IM messages can currently handle up to 400 characters per message and so it would be likely that the sending of a full message would require several IM messages to be sent each containing a part of the overall message. At the recipient, the content of the different IM messages would not only be recorded but also compiled together to form the fill message. This would be carried out in the same way that the component e-mail assembly is carried out in the above described embodiments, namely by provision of a message identifier in each IM message which allowed the different IM messages to be compiled together later.

More specifically, a sniffer process can be provided to intercept messages arriving at an Instant Messenger window. It detects (and collates, if necessary) Clovis messages, and passes the result to the Clovis plug-in. Collation is necessary, when the complete “message” is longer than the maximum Instant Messenger message size. In the case of the partial IM message, each IM part is additionally tagged with the complete message's unique ID.

It is to be appreciated that most of the features of the three above-described embodiments are readily interchangeable. For example, it is possible to incorporate schema control of the second embodiment with the remote updating of the third embodiment. Clearly, in this case it would be necessary to use structured e-mail to convey the remote commands to carry out the actions on the recipient's computer 1 8.

Having described particular preferred embodiments of the present invention, it is to be appreciated that the embodiments in question are exemplary only and that variations and modifications such as will occur to those possessed of the appropriate knowledge and skills may be made without departure from the spirit and scope of the invention as set forth in the appended claims. For example, the present embodiments have described the use of XML inserted within an e-mail, however other non XML ways of defining data structures could also be employed such as using a name equals value approach which would be a new way of defining a data structure in text.

1. A method of filing a received e-mail message, the method comprising:
reading a self-describing text-based data structure within the text body of the received e-mail message;
comparing the self-describing data structure to a plurality of pre-stored text-based data structures; and
storing the received data content of the e-mail message or a significant part thereof in a selected data folder to which the received text-based data structure corresponds,
the method requiring no external access to data to carry out the reading, comparing and storing steps.

2. A method according to claim 1, further comprising:
creating a new data folder if the received text-based data structure does not correspond to any of the plurality of pre-stored text-based data structures; and
the storing step comprises storing the received e-mail message or a significant part thereof in the new data folder.

3. A method according to claim 2, further comprising:
adding the received text-based structure to the plurality of pre-stored text-based data structures; and
associating the received text-based structure with the new folder.

4. A method according to claim 1, wherein the received text-based data structure comprises a plurality of data sets, and the storing step comprises:
storing each of the different data sets as a record that can be separately manipulated in the selected folder.

5. A method according to claim 1, wherein the received text-based structure causes an interaction action to occur with previously received or existing data.

6. A method according to claim 5, wherein the interaction action comprises the storing step including overwriting a data set of a text-based data structure previously stored within the folder with a data set of the received text-based data structure.

7. A method according to claim 5, wherein the received e-mail specifies matching data and certain fields of the data structure, and the interaction action comprises:
comparing the matching data for the certain fields of a previously stored data set; and
interacting with the data set where the data stored in the certain fields matches the matching data.

8. A method according to claim 7, wherein the interacting step comprises updating the data set where the data stored in the certain fields matches the matching data.

9. A method according to claim 8, wherein the updating step comprises deleting the data set.

10. A method according to claim 9, wherein the updating step further comprises inserting the data set provided in the received e-mail in place of the deleted data set.

11. A method according to claim 5, wherein the storing step comprises overwriting a text-based data structure previously stored within the folder with the received text-based data structure.

12. A method according to claim 1, further comprising:
using the self-describing data structure to create a new definition for a folder; and
applying that new definition to a new folder or an existing folder.

13. A method according to claim 12, further comprising updating a definition of an existing data folder with the new folder definition if the received text-based data structure does not correspond to any of the plurality of pre-stored text-based data structures and an identifier of the data structure matches that of the existing folder.

14. A method according to claim 1, wherein the storing step comprises storing the received data in a database and the method further comprises using database data handling techniques to manipulate at least part of the stored data.

15. A method according to claim 1, further comprising sorting contents of the selected folder according to a user-selected characteristic.

16. A method according to claim 1, further comprising writing the text-based data structure to a database file external to an e-mail function by which the data structure was received.

17. A method according to claim 16, wherein the data structure comprises a processing command for controlling an application which has access to the external database file.

18. A method according to claim 1, wherein the data structure comprises a processing command for controlling any aspect of the method.

19. A method according to claim 1, wherein at least a portion of the text-based data structure is encoded and the method further comprises decoding the portion of the received text-based data structure before the comparing step.

20. A method according to claim 19, wherein the received e-mail message contains an encrypted licence from a sender authenticating the sender.

21. A method according to claim 20, wherein the encrypted licence comprises the self-describing text-based data structure.

22. A method according to claim 1, further comprising comparing a current date with the date of receipt of a previously filed e-mail, and removing the previously filed e-mail if a time period between the dates exceeds a predetermined amount.

23. A method according to claim 22, wherein the received e-mail message comprises an expiry time and the removing step comprises removing the previously filed e-mail if the expiry time has lapsed.

24. A method according to claim 22, wherein received e-mail comprises a deletion instruction and the comparing and removal steps are carried out on reading of the deletion instruction.

25. A method according to claim 1, wherein the text-based data structure comprises a data structure written in a command language such as XML.

26. A method according to claim 25, wherein the text-based data structure comprises an XML schema and the e-mail message further comprises data conforming to the XML schema.

27. An apparatus for filing a newly received e-mail message, the apparatus comprising:
a store of text-based data structures, each text-based structure corresponding to a particular e-mail folder;
reading means for reading a self-describing text-based data structure within the text body of the newly received e-mail message;
a comparator for comparing the received self-describing data structure to each of the plurality of pre-stored text-based data structures; and
filing means for filing the received e-mail message in a selected folder to which the received text-based data structure corresponds,
wherein the operation of the apparatus in filing a newly received e-mail requires no external access to data.

28. An apparatus according to claim 27, wherein the reading means, the comparator and the filing means comprise an e-mail management application and a plug-in.

29. A method of a recipient processing a received e-mail to cause data interaction; the method comprising:
reading a text-based data structure within the text body of the received e-mail message;
identifying some pre-stored data of the recipient by use of the data structure;
causing an interaction to occur with the pre-stored data, the interaction being determined by the contents of the received e-mail.

30. A method according to claim 29, wherein the interaction is determined by the text-based structure.

31. A method according to claim 29, wherein the e-mail comprises a data payload conforming to the data structure and the causing step comprises an interaction between the pre-stored data and the received data payload.

32. A method according to claim 31, wherein the interaction comprises overwriting the prestored data with the payload data.

33. A method according to claim 29, wherein the interaction comprises deleting the pre-stored data.

34. An apparatus for processing a received e-mail to cause data interaction; the apparatus comprising:
reading means for reading a text-based data structure within the text body of the received e-mail message;
identifying means for identifying some pre-stored data of the recipient by use of the data structure; and
interaction means for causing an interaction to occur with the pre-stored data, the interaction means being arranged to be controlled by the contents of the received e-mail.

35. A method of updating a remote data structure or process, the method comprising:
reading a text-based processing instruction within the text body of a received e-mail message;
accessing pre-stored data relating to the remote data structure or process;
updating the pre-stored data in accordance with the text-based processing instruction to effect control.

36. A method according to claim 35, wherein the updating step comprises updating a sender-defined database on a recipient's computer.

37. A method according to claim 35, wherein the updating step comprises updating a functional capability of a recipient's program;

38. A method according to claim 35, wherein the updating step comprises updating the executable code of a program provided at the recipient.

39. A method according to claim 35, wherein the updating step comprises issuing commands to a program provided at the recipient.

40. A method according to claim 35, wherein the updating step comprises issuing commands indirectly to other programs.

41. A system for updating a remote data structure or process, the system comprising:
reading means for reading a text-based processing instruction within the text body of a received e-mail message;
accessing means for accessing pre-stored data relating to the remote data structure or process;
updating means for updating the pre-stored data in accordance with the text-based processing instruction to effect control.

42. A method of filing content of a received instant messaging communication, the method comprising:
reading a self-describing text-based data structure within the text body of the received instant messaging communication;
comparing the self-describing data structure to a plurality of pre-stored text-based data structures; and
storing the received data content of the instant messaging communication or a significant part thereof in a selected data folder to which the received text-based data structure corresponds,
the method requiring no external access to data to carry out the reading, comparing and storing steps.

43. A method of updating a remote data structure or process, the method comprising:
reading a text-based processing instruction within the text body of a received instant messaging communication;
accessing pre-stored data relating to the remote data structure or process;
updating the pre-stored data in accordance with the text-based processing instruction to effect control.

44. A method of a recipient processing a received instant messaging communication to cause data interaction; the method comprising:
reading a text-based data structure within the text body of the received instant messaging communication;
identifying some pre-stored data of the recipient by use of the data structure;
causing an interaction to occur with the pre-stored data, the interaction being determined by the contents of the received instant messaging communication.

45. A method of filing a received e-mail message, the method comprising:
reading a self-describing text-based data structure within the text body of the received e-mail message;
comparing the self-describing data structure to a plurality of pre-stored text-based data structures;
if a corresponding pre-stored text-based data structure has been determined, storing the received data content of the e-mail message or a significant part thereof to a selected data folder associated with the corresponding text-based data structure;
if a corresponding pre-stored text-based data structure has not been determined:
creating a new data folder;
storing the received e-mail message or a significant part thereof in the new data folder;
adding the received text-based structure to the plurality of pre-stored text-based data structures; and
associating the received text-based structure with the new folder,
wherein the method requires no external access to data to carry out the reading, comparing, creating and storing steps.

46. A method of filing a received e-mail message, the method comprising:
reading a self-describing text-based data structure within the text body of the received e-mail message, the received e-mail specifying matching data and certain fields of the data structure;
comparing the self-describing data structure to a plurality of pre-stored text-based data structures;
storing the received data content of the e-mail message or a significant part thereof in a selected data folder to which the received text-based data structure corresponds,
wherein the storing step causes an interaction action to occur with previously received or existing data in the selected data folder, the interaction action comprising:
assessing the matching data for the specified certain fields of a previously stored data set; and
interacting with the data set where the data stored in the specified certain fields matches the matching data,
and wherein the method requires no external access to data to carry out the reading, comparing and storing steps.

47. A method of filing a received e-mail message, the method comprising:
reading a self-describing text-based data structure within the text body of the received e-mail message;
comparing the self-describing data structure to a plurality of pre-stored text-based data structures;
storing the received data content of the e-mail message or a significant part thereof in a selected data folder to which the received text-based data structure corresponds,
wherein the storing step causes an interaction action to occur with previously received or existing data in the selected data folder, the interaction action comprising:
overwriting a text-based data structure previously stored within the folder with the received text-based data structure;
and wherein the method requires no external access to data to carry out the reading, comparing and storing steps.

48. A method of filing a received e-mail message, the method comprising:
reading a self-describing text-based data structure within the text body of the received e-mail message;
comparing the self-describing data structure to a plurality of pre-stored text-based data structures;
if a corresponding pre-stored text-based data structure has been determined, storing the received data content of the e-mail message or a significant part thereof in a selected data folder to which the received text-based data structure corresponds;
using the self-describing data structure to create a new definition for a folder; and
updating a definition of an existing data folder with the new folder definition if the received text-based data structure does not correspond to any of the plurality of pre-stored text-based data structures and an identifier of the data structure matches that of the existing folder;
wherein the method requires no external access to data to carry out the reading, comparing and storing steps.

49. A method of filing a received e-mail message, the method comprising:
reading a self-describing text-based data structure within the text body of the received e-mail message;
comparing the self-describing data structure to a plurality of pre-stored text-based data structures; and
storing the received data content of the e-mail message or a significant part thereof in a selected data folder to which the received text-based data structure corresponds, the selected data folder being a database file residing locally and externally to an e-mail function by which the data structure was received,
wherein the method requires no non-local access to data to carry out the reading, comparing and storing steps, and
wherein the data structure comprises a processing command for controlling an application which has access to the local database file.

50. A method of filing a received e-mail message, the method comprising:
reading a self-describing text-based data structure within the text body of the received e-mail message, at least a portion of the self-describing text-based data structure being encrypted;
decrypting the encrypted portion of the self-describing text-based data structure, the encrypted portion comprising an encrypted licence from a sender of the e-mail, the licence authenticating the sender and including the at least a portion of the self-describing text-based data structure;
comparing the decrypted self-describing data structure to a plurality of pre-stored text-based data structures; and
storing the received data content of the e-mail message or a significant part thereof in a selected data folder to which the received text-based data structure corresponds,
wherein the method requires no external access to data to carry out the reading, comparing and storing steps.

51. A method according to claim 50, further comprising using the licence details to carry out an authentication of the sender.

52. A method of filing a received e-mail message, the method comprising:
reading a self-describing text-based data structure within the text body of the received e-mail message; comparing the self-describing data structure to a plurality of pre-stored text-based data structures, including comparing a current date with the date of receipt of a previously filed e-mail in a selected data folder to which the received text-based data structure corresponds;
storing the received data content of the e-mail message or a significant part thereof in the selected data folder; and
removing the previously filed e-mail if a time period between the dates exceeds a predetermined amount,
wherein the method requires no external access to data to carry out the reading, comparing and storing steps.

53. A method of a recipient processing a received e-mail message to cause data interaction; the method comprising:
reading a text-based data structure within the text body of the received e-mail message, together with a data payload conforming to the text-based data structure;
identifying pre-stored data of the recipient by use of the read text-based data structure; and
causing an interaction to occur between the pre-stored data and the received data payload, the interaction comprising an action of overwriting the prestored data with the payload data and being determined by the contents of the received e-mail.
